(19) United States
(12) Patent Application Publication
(10) Pub. No.: US 2026/0186273 A1
(43) Pub. Date: Jul. 2, 2026

(54) Camera Optical Lens

(71) Applicant: Changzhou AAC Raytech Optronics Co., Ltd., Changzhou City (CN)

(72) Inventor: Yongqiang Yang, Changzhou (CN)

(21) Appl. No.: 19/295,738

(22) Filed: Aug. 11, 2025

Related U.S. Application Data
(63) Continuation of application No. PCT/CN2024/144492, filed on Dec. 31, 2024.

(51) Int. Cl. G02B 13/00

(52) U.S. Cl. CPC G02B 13/007

(57) ABSTRACT

The present disclosure discloses a camera optical lens including: a first prism, a first lens having a negative refractive power, a second lens having a positive refractive power, a third lens having a negative refractive power, a fourth lens having a positive refractive power, and a fifth lens. The first lens is defined as a first lens group, the second, third, fourth, and fifth lenses are defined as a second lens group, the second lens group is adjustably movable along the optical axis of the camera optical lens to switch the camera optical lens between a first state and a second state. The focal length of the camera optical lens in the first state is fA. The image height of the camera optical lens is IH, and the camera optical lens satisfies: 4.60≤fA/IH≤4.90. The camera optical lens achieves a high-aperture periscope-type design with superior optical performance.

### CROSS-REFERENCE TO RELATED APPLICATIONS

This application claims the priority benefit of PCT Patent Application Ser. No. PCT/CN2024/144492 filed on Dec. 31, 2024, the entire content of which is incorporated herein by reference.

### FIELD OF THE PRESENT DISCLOSURE

The present disclosure relates to optical lens, in particular to a camera optical lens suitable for portable terminal devices such as smartphones and digital cameras, as well as imaging devices including monitors and PC cameras.

### DESCRIPTION OF RELATED ART

In recent years, with the rise of smartphones, the demand for miniaturized camera lenses has progressively increased. Due to the pixel size of image sensors has been reduced, combined with the trend of electronic products toward high functionality and slim, compact form factors, miniaturized camera lenses possessing superior imaging quality have consequently become the mainstream in the current market. Among these, internal focus camera lenses are progressively adopted in smartphone cameras owing to their high stability, rapid focusing response, superior cleanliness, and ability to overcome wear issues inherent in external focus mechanisms.

Additionally, while telephoto cameras meet consumer demand for capturing distant subjects, conventional telephoto designs exhibit excessive total optical length, conflicting with smartphones' slim form factor requirements. The periscope-type telephoto design significantly reduces total optical length while maintaining long-focus capabilities. However, existing periscope telephoto lenses still fail to satisfy optical performance demands.

### SUMMARY

To address the above issues, it is an object of the present disclosure to provide a camera optical lens that achieves excellent optical performance while simultaneously meeting the design requirements of a large aperture, miniaturization, and long focal length.

In order to overcome shortcomings in the prior art, the present disclosure provides a camera optical lens including, in an order from an object side to an image side in sequence: a first prism, a first lens with a negative refractive power, a second lens with a positive refractive power, a third lens with a negative refractive power, a fourth lens with a positive refractive power, and a fifth lens; wherein
the first lens is defined as a first lens group, while the second, third, fourth, and fifth lenses are defined as a second lens group, the second lens group is adjustably movable along the optical axis of the camera optical lens to switch the camera optical lens between a first state and a second state, the camera optical lens achieves its maximum focal length in the first state, and achieves its minimum focal length in the second state;
a reflective surface is disposed between the object side surface and image side surface of the first prism, and the camera optical lens further satisfies the following conditions:

$$\begin{matrix}4.6 \leq fA / IH \leq 4.9 ; \\ - 4. \leq Rp 1 / Rp 2 \leq 0.71 ; \\ 0.3 \leq fb / fa \leq 1.3 ; \\ 0. 15 \leq BF / TTL \leq 0 \text{.40} ;\end{matrix}$$

where
fA: the focal length of the camera optical lens in the first state;
IH: the image height of the camera optical lens;
Rp1: the central curvature radius of the object side surface of the first prism;
Rp2: the central curvature radius of the image side surface of the first prism;
fb: the focal length of the second lens group when the camera optical lens in the first sate;
fa: the focal length of non-prism section excluding the first prism when the camera optical lens in the first sate;
BF: the distance from the image side surface of the fifth lens to the image side when the camera optical lens in the first state;
TTL: the total optical length of the camera optical lens.

As an improvement, the camera optical lens further satisfies the following condition:

$$0.7 \leq f 4 / ( R 7 + R 8 ) \leq 3 \text{.00} ;$$

where
f4: the focal length of the fourth lens;
R7: the central curvature radius of the object side surface of the fourth lens;
R8: the central curvature radius of the image side surface of the fourth lens.

As an improvement, the camera optical lens further satisfies the following conditions:

$$\begin{matrix}- 16.60 \leq fp 1 / fA \leq 3.93 ; \\ 0.3 \leq dp 1 / TTL \leq 0 \text{.37} ;\end{matrix}$$

where
fp1: the focal length of the first prism;
dp1: the sum of the distance on-axis from the object side surface of the first prism to the reflective surface, and the distance on-axis from the reflective surface to the image side surface of the first prism.

As an improvement, an object side surface of the first lens is convex in the paraxial region, an image side surface of the first lens is concave in the paraxial region, and the camera optical lens further satisfies the following conditions:

$$\begin{matrix}- 8.39 \leq f 1 / fA \leq - 1 \text{.34} ; \\ 1.91 \leq ( R 1 + R 2 ) / ( R 1 - R 2 ) \leq 13 \text{.57} ; \\ 0.019 \leq d 1 / TTL \leq 0.023 ;\end{matrix}$$

where
f1: the focal length of the first lens;
R1: the central curvature radius of the object side surface of the first lens;
R2: the central curvature radius of the image side surface of the first lens;
d1: the thickness on-axis of the first lens

As an improvement, an object side surface of the second lens is convex in the paraxial region, an image side surface of the second lens is convex in the paraxial region, and the camera optical lens further satisfies the following conditions:

$$\begin{matrix}0.41 \leq f 2 / fA \leq 0.46 ; \\ - 0.4 \; 2 \leq ( R 3 + R 4 ) / ( R 3 - R 4 ) \leq 0 \text{.00} ; \\ 0.089 \leq d 3 / TTL \leq 0.1 \; 17 ;\end{matrix}$$

where
f2: the focal length of the second lens;
R3: the central curvature radius of the object side surface of the second lens;
R4: the central curvature radius of the image side surface of the second lens;
d3: the thickness on-axis of the second lens.

As an improvement, an object side surface of the third lens is concave in the paraxial region, an image side surface of the third lens is concave in the paraxial region, and the camera optical lens further satisfies the following conditions:

$$\begin{matrix}- 0.51 \leq f 3 / fA \leq - 0.35 ; \\ - 0.6 \; 0 \leq ( R 5 + R 6 ) / ( R 5 - R 6 ) \leq - 0 \text{.06} ; \\ 0.01 6 \leq d 5 / TTL \leq 0 \text{.067} ;\end{matrix}$$

where
f3: the focal length of the third lens;
R5: the central curvature radius of the object side surface of the third lens;
R6: the central curvature radius of the image side surface of the third lens;
d5: the thickness on-axis of the third lens

As an improvement, an object side surface of the fourth lens is convex in the paraxial region, an image side surface of the fourth lens is concave in the paraxial region, and the camera optical lens further satisfies the following conditions:

$$\begin{matrix}1.15 \leq f 4 / fA \leq 2.01 ; \\ - 10.17 \leq ( R 7 + R 8 ) / ( R 7 - R 8 ) \leq - 2.55 ; \\ 0.025 \leq d 7 / TTL \leq 0.0 \; 33 ;\end{matrix}$$

where
f4: the focal length of the fourth lens;
R7: the central curvature radius of the object side surface of the fourth lens;
R8: the central curvature radius of the image side surface of the fourth lens;
d7: the thickness on-axis of the fourth lens.

As an improvement, an object side surface of the fifth lens is convex in the paraxial region, an image side surface of the fifth lens is concave in the paraxial region, and the camera optical lens further satisfies the following conditions:

$$\begin{matrix}- 452.41 \leq f 5 / fA \leq 1 0.01 ; \\ 6.81 \leq ( R 9 + R 10 ) / ( R 9 - R 10 ) \leq 5 2.78 ; \\ 0.019 \leq d 9 / TTL \leq 0.0 \; 39 ;\end{matrix}$$

f5: the focal length of the fifth lens;
R9: the central curvature radius of the object side surface of the fifth lens;
R10: the central curvature radius of the image side surface of the fifth lens;
d9: the thickness on-axis of the fifth lens.

As an improvement, the camera optical lens further satisfies the following conditions: the first prism is made of glass material.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a schematic diagram of a camera optical lens in accordance with a first embodiment of the present disclosure in a first state;

FIG. 2 shows the lateral color of the camera optical lens shown in FIG. 1;

FIG. 3 shows the longitudinal aberration of the camera optical lens shown in FIG. 1;

FIG. 4 presents a schematic diagram of the field curvature and distortion of the camera optical lens shown in FIG. 1;

FIG. 5 is a schematic diagram of a camera optical lens in accordance with a first embodiment of the present disclosure in a second state;

FIG. 6 shows the lateral color of the camera optical lens shown in FIG. 5;

FIG. 7 shows the longitudinal aberration of the camera optical lens shown in FIG. 5;

FIG. 8 presents a schematic diagram of the field curvature and distortion of the camera optical lens shown in FIG. 5;

FIG. 9 is a schematic diagram of a camera optical lens in accordance with a second embodiment of the present disclosure in a first state;

FIG. 10 shows the lateral color of the camera optical lens shown in FIG. 9;

FIG. 11 shows the longitudinal aberration of the camera optical lens shown in FIG. 9;

FIG. 12 presents a schematic diagram of the field curvature and distortion of the camera optical lens shown in FIG. 9;

FIG. 13 is a schematic diagram of a camera optical lens in accordance with a second embodiment of the present disclosure in a second state;

FIG. 14 shows the lateral color of the camera optical lens shown in FIG. 13;

FIG. 15 shows the longitudinal aberration of the camera optical lens shown in FIG. 13;

FIG. 16 presents a schematic diagram of the field curvature and distortion of the camera optical lens shown in FIG. 13;

FIG. 17 is a schematic diagram of a camera optical lens in accordance with a third embodiment of the present disclosure in a first state;

FIG. 18 shows the lateral color of the camera optical lens shown in FIG. 17;

FIG. 19 shows the longitudinal aberration of the camera optical lens shown in FIG. 17;

FIG. 20 presents a schematic diagram of the field curvature and distortion of the camera optical lens shown in FIG. 17;

FIG. 21 is a schematic diagram of a camera optical lens in accordance with a third embodiment of the present disclosure in a second state;

FIG. 22 shows the lateral color of the camera optical lens shown in FIG. 21;

FIG. 23 shows the longitudinal aberration of the camera optical lens shown in FIG. 21;

FIG. 24 presents a schematic diagram of the field curvature and distortion of the camera optical lens shown in FIG. 21;

FIG. 25 is a schematic diagram of a camera optical lens in accordance with a fourth embodiment of the present disclosure in a first state;

FIG. 26 shows the lateral color of the camera optical lens shown in FIG. 25;

FIG. 27 shows the longitudinal aberration of the camera optical lens shown in FIG. 25;

FIG. 28 presents a schematic diagram of the field curvature and distortion of the camera optical lens shown in FIG. 25;

FIG. 29 is a schematic diagram of a camera optical lens in accordance with a fourth embodiment of the present disclosure in a second state;

FIG. 30 shows the lateral color of the camera optical lens shown in FIG. 29;

FIG. 31 shows the longitudinal aberration of the camera optical lens shown in FIG. 29;

FIG. 32 presents a schematic diagram of the field curvature and distortion of the camera optical lens shown in FIG. 29;

FIG. 33 is a schematic diagram of a camera optical lens in accordance with a fifth embodiment of the present disclosure in a first state;

FIG. 34 shows the lateral color of the camera optical lens shown in FIG. 33;

FIG. 35 shows the longitudinal aberration of the camera optical lens shown in FIG. 33;

FIG. 36 presents a schematic diagram of the field curvature and distortion of the camera optical lens shown in FIG. 33;

FIG. 37 is a schematic diagram of a camera optical lens in accordance with a fifth embodiment of the present disclosure in a second state;

FIG. 38 shows the lateral color of the camera optical lens shown in FIG. 37;

FIG. 39 shows the longitudinal aberration of the camera optical lens shown in FIG. 37;

FIG. 40 presents a schematic diagram of the field curvature and distortion of the camera optical lens shown in FIG. 37;

FIG. 41 is a schematic diagram of a camera optical lens in accordance with a sixth embodiment of the present disclosure in a first state;

FIG. 42 shows the lateral color of the camera optical lens shown in FIG. 41;

FIG. 43 shows the longitudinal aberration of the camera optical lens shown in FIG. 42;

FIG. 44 presents a schematic diagram of the field curvature and distortion of the camera optical lens shown in FIG. 42;

FIG. 45 is a schematic diagram of a camera optical lens in accordance with a sixth embodiment of the present disclosure in a second state;

FIG. 46 shows the lateral color of the camera optical lens shown in FIG. 45;

FIG. 47 shows the longitudinal aberration of the camera optical lens shown in FIG. 45;

FIG. 48 presents a schematic diagram of the field curvature and distortion of the camera optical lens shown in FIG. 45.

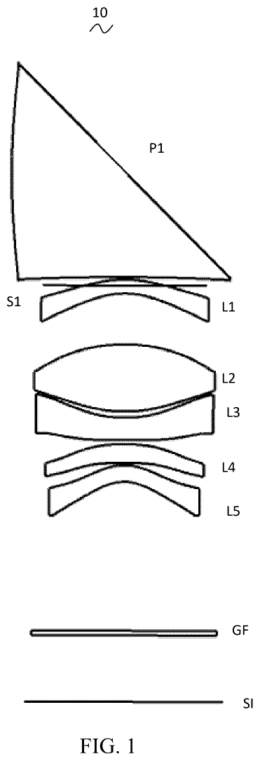

### DETAILED DESCRIPTION OF THE EXEMPLARY EMBODIMENTS

The present disclosure will hereinafter be described in detail with reference to several exemplary embodiments. To make the technical problems to be solved, technical solutions and beneficial effects of the present disclosure more apparent, the present disclosure is described in further detail together with the figure and the embodiments. It should be understood the specific embodiments described hereby is only to explain the disclosure, not intended to limit the disclosure.

With reference to the accompanying drawings, the present disclosure provides camera optical lenses 10, 20, 30, 40, 50, and 60. The camera optical lenses 10, 20, 30, 40, 50, 60 each includes, sequentially arranged from the object side to the image side: a first prism P1, a first lens L1 with negative refractive power, a second lens L2 with positive refractive power, a third lens L3 with negative refractive power, a fourth lens L4 with positive refractive power, and a fifth lens L5.

The first lens L1 is defined as a first lens group, and the second lens L2, the third lens L3, the fourth lens L4, and the fifth lens L5 are defined as a second lens group. The second lens group is movably focused and configured to be adjustably movable along the optical axis of the camera optical lenses 10-60, thereby enabling the camera optical lenses 10-60 to switch between a first state and a second state. Thus, the first lens group serves as a fixed-focal-length group, while the second lens group functions as a movable zoom group. By displacing the second lens group, a change in focal length of the camera optical lenses 10-60 is achieved, such that the camera optical lenses 10-60 maintain superior imaging performance in both the first state and the second state, wherein the first state corresponds to a state where the focal length of the camera optical lenses 10-60 is maximized, and the second state corresponds to a state where the focal length of the camera optical lenses 10-60 is minimized. For example, the first state may be a telephoto state or a state with an object distance at infinity, the second state may be a short-focus state, a macro state, or a state with an object distance of 200 mm. Thereby, the camera optical lenses 10-60 achieve an internal focusing mode by movably focusing the second lens group.

By implementing movable focusing of the second lens group, the focusing process becomes faster and smoother, thereby optimizing spatial allocation within the internal structure of the camera optical lenses 10-60.

A reflective surface is disposed between the object side surface and the image side surface of the first prism P1. The focal length of the camera optical lenses 10-60 is defined as fA, the image height of the camera optical lenses 10-60 is defined as IH, and the following condition is satisfied: 4.60≤fA/IH≤4.90. By constraining the ratio of the focal length to the image height of the camera optical lenses 10-60. the camera optical lenses 10-60 satisfying this condition achieves an extended focal length when the image height is fixed, thereby enhancing the magnification capability of the camera optical lenses 10-60.

The central curvature radius of the object side surface of the first prism P1 is defined as Rp1, the central curvature radius of the image side surface of the first prism P1 is defined as Rp2, and the following condition is satisfied: −4.00≤Rp1/Rp2≤0.71. By constraining the concave-convex shape of the first prism P1 within the conditional range, the degree of light deflection upon entering the first prism P1 is mitigated, thereby facilitating subsequent stable light propagation.

The focal length of the second lens group when the camera optical lenses 10-60 in the first sate is defined as fb, the focal length of non-prism section excluding the first prism when the camera optical lenses 10-60 in the first sate is defined as fa, and the following condition is satisfied: 0.30≤fb/fa≤1.30. In the first state of the camera optical lens 10-60, the ratio of the focal length of the second lens group to the focal length of the non-prism portion satisfies specific relational expressions. Through rational allocation of the optical focal lengths, the camera optical lenses 10-60 achieve enhanced imaging quality and reduced system sensitivity.

The distance from the image side surface of the fifth lens to the image side when the camera optical lens in the first state is defined as BF, the total optical length of the camera optical lens is defined as TTL, and the following condition is satisfied: 0.15≤BF/TTL≤0.40. By achieving miniaturization of the camera optical lenses 10-60 while maintaining a long back focal length (BFL), the assembly of the optical camera lenses 10-60 is facilitated, and the total length of the optical system is effectively controlled.

Under the constraints of the aforementioned conditional expressions, the camera optical lenses 10-60 exhibit superior optical performance while satisfying the design requirements of large aperture, long focal length, and compact size. Given these characteristics, the camera optical lenses 10-60 are particularly suitable for high-pixel CCD/CMOS imaging sensors in mobile phone camera modules and webcam lenses.

Based on the above conditional expressions and functional capabilities, the features of each lens are further refined as follows.

In the present disclosure, the focal length of the fourth lens L4 is defined as f4, the central curvature radius of the object side surface of the fourth lens L4 is defined as R7, the central curvature radius of the image side surface of the fourth lens L4 is defined as R8, and the following condition is satisfied: 0.70≤f4/(R7+R8)≤3.00. By constraining the conditional expressions within appropriate ranges, the optical power of the fourth lens L4 is limited to a rational scope, thereby reducing tolerance sensitivity. Simultaneously, constraining the curvature radius of the object side and image side surfaces of the fourth lens L4 within reasonable bounds ensures that tolerance requirements align with existing manufacturing process capabilities. This configuration effectively balances aberrations in the optical system and guarantees imaging quality.

In the present disclosure, the object side surface of the first prism P1 is convex or concave in the paraxial region, the image side surface of the first prism P1 is convex or concave in the paraxial region, the first prism P1 has a positive refractive power. The focal length of the first prism P1 is defined as fp1, and the following condition is satisfied: −16.60≤fp1/fA≤3.93. By controlling the optical power of the first prism P1 within an appropriate range, it facilitates the correction of aberrations in the optical system.

The sum of the distance on-axis from the object side surface of the first prism P1 to the reflective surface, and the distance on-axis from the reflective surface to the image side surface of the first prism P1 is defined as dp1, the total optical length of the camera optical lenses 10-60 is defined as TTL, and the following condition is satisfied: 0.30≤dp1/TTL≤0.37. By constraining within the range of conditional expressions, rational control to the total optical length of the camera optical lenses 10-60 is facilitated. In the present disclosure, the object side surface of the first lens L1 is convex at the paraxial region, and the image side surface of the first lens L1 is concave at the paraxial region. Alternatively, the object side and image side surfaces of the first lens L1 may be configured with other concave/convex distributions.

The focal length of the first lens L1 is defined as f1, and the following condition is satisfied: −8.39≤f1/fA≤−1.34. By constraining the negative optical power of the first lens L1 within an appropriate range, aberrations of the optical system can be effectively corrected.

The central curvature radius of the object side surface of the first lens L1 is defined as R1, the central curvature radius of the image side surface of the first lens L1 is defined as R2, and the following condition is satisfied: 1.91≤(R1+R2)/(R1-R2)≤13.57, which rationally controls the shape of the first lens L1 and enables the first lens L1 to correct spherical aberration of the system effectively. The thickness on-axis of the first lens L1 is defined as d1, the total optical length of the camera optical lenses 10-60 is defined as TTL, and the following condition is satisfied: 0.019≤d1/TTL≤0.023. Within this conditional range, it facilitates rational control of the total optical length of the camera optical lenses 10-60.

In the present disclosure, the object side surface of the second lens L2 is convex in the paraxial region, and the image side surface of the second lens L2 is convex in the paraxial region. Alternatively, the object side and image side surfaces of the second lens L2 may be configured with other concave/convex distributions.

The focal length of the second lens L2 is defined as f2, and the following condition is satisfied: 0.41≤f2/fA≤0.46. By constraining the positive optical power of the second lens L2 within a reasonable range, aberrations of the optical system can be effectively corrected.

The central curvature radius of the object side surface of the second lens L2 is defined as R3, the central curvature radius of the image side surface of the second lens L2 is defined as R4, and the following condition is satisfied: −0.42≤(R3+R4)/(R3−R4)≤0.00. This constrains the shape of L2. Within this range, as the lens becomes more compact, it facilitates correction of axial chromatic aberration.

The thickness on-axis of the second lens L2 is defined as d3, the total optical length of the camera optical lenses 10-60 is defined as TTL, and the following condition is satisfied: 0.089≤d3/TTL≤0.117. Within this conditional range, it facilitates rational control of the total optical length of the camera optical lenses 10-60.

In the present disclosure, the object side surface of the third lens L3 is concave in the paraxial region, and the image side surface of the third lens L3 is concave in the paraxial region. Alternatively, the object side and image side surfaces of the third lens L3 may be configured with other concave/convex distributions.

The focal length of the third lens L3 is defined as f3, and the following condition is satisfied: −0.51≤f3/fA≤−0.35. By constraining the negative optical power of the third lens L3 within a reasonable range, aberrations of the optical system can be effectively corrected.

The central curvature radius of the object side surface of the third lens L3 is defined as R5, and the central curvature radius of the image side surface of the third lens L3 is defined as R6, and the following condition is satisfied: −0.60≤(R5+R6)/(R5−R6)≤−0.06. This constrains the shape of the third lens L3, facilitating its manufacturability. Within this conditional range, it mitigates ray deflection through the lens and effectively reduces aberrations.

The thickness on-axis of the third lens L3 is defined as d5, the total optical length of the camera optical lenses 10-60 is defined as TTL, and the following condition is satisfied: 0.016≤d5/TTL≤0.067. Within this range, it facilitates rational control of the total optical length of the camera optical lenses 10-60.

In the present disclosure, the object side surface of the fourth lens L4 is convex in the paraxial region, and the image-side surface of the fourth lens L4 is concave in the paraxial region. In other alternative embodiments, the object side and image side surfaces of the fourth lens L4 may be configured with other concave/convex distributions.

The focal length of the fourth lens L4 is defined as f4, and the following condition is satisfied: 1.15≤f4/fA≤2.01. By constraining the positive optical power of the fourth lens L4 within a reasonable range, aberrations of the optical system can be effectively corrected, enabling superior imaging quality and lower sensitivity.

The central curvature radius of the object-side surface of the fourth lens L4 is defined as R7, and the central curvature radius of the fourth lens L4 of the image-side surface is defined as R8, and the following condition is satisfied: −10.17≤(R7+R8)/(R7−R8)≤−2.55. This constrains the shape of the fourth lens L4. Within this range, as miniaturization progresses, it facilitates correction of off-axis field angle aberrations.

The thickness on-axis of the fourth lens L4 is defined as d7, the total optical length of the camera optical lenses 10-60 is defined as TTL, and the following condition is satisfied 0.025≤d7/TTL≤0.033. Within this conditional range, it facilitates rational control of the total optical length of the camera optical lenses 10-60.

In the present disclosure, the object side surface of the fifth lens L5 is convex in the paraxial region, and the image side surface of the fifth lens L5 is concave in the paraxial region. The fifth lens L5 has a positive or negative refractive power. In other alternative embodiments, the object side and image side surfaces of the fifth lens L5 may be configured with other concave/convex distributions.

The focal length of the fifth lens L5 is defined as f5, and the following condition is satisfied: −452.41≤f5/fA≤10.01. By constraining the optical power of the fifth lens L5 within a reasonable range, aberrations of the optical system can be effectively corrected.

The central curvature radius of the object side surface of the fifth lens L5 is defined as R9, the central curvature radius of the image side surface of the fifth lens L5 is defined as R10, and the following condition is satisfied: 6.81≤(R9+R10)/(R9−R10)≤52.78. This constrains the shape of the fifth lens L5. Within this range, as miniaturization progresses, it facilitates correction of off-axis field angle aberrations.

The thickness on-axis of the fifth lens L5 is defined as d9, the total optical length of the camera optical lenses 10-60 is defined as TTL, and the following condition is satisfied: 0.019≤d9/TTL≤0.039. Within this conditional range, it facilitates rational control of the total optical length of the camera optical lenses 10-60.

In the present disclosure, the first prism P1 is made of glass material, the first lens L1 is made of plastic material, the second lens L2 is made of plastic material, the third lens L3 is made of plastic material, the fourth lens L4 is made of plastic material, and the fifth lens L5 is made of plastic material. The first prism P1 and each lens may also be made of other materials.

In the present disclosure, an aperture stop S1 is further disposed between the first prism P1 and the first lens L1, and the aperture stop S1 may also be disposed at other positions.

Between the fifth lens L5 and the image plane SI, an optical filter GF may be disposed-which may be a glass cover plate or an optical filter (e.g., spectral filter).

In the present disclosure, the F-number (FNO) of the camera optical lenses 10-60 is less than or equal to 2.26, thereby achieving a large aperture and superior imaging performance. Preferably, the F-number (FNO) of the camera optical lens 10 is less than or equal to 2.22.

The camera optical lenses of the present disclosure will be described below with reference to various embodiments. The symbols used in each embodiment are as follows. The focal length, the distance on-axis, the central curvature radius, and the thickness on-axis are expressed in millimeters.

TTL: Total optical length (the distance on-axis from the object side surface of the first prism P1 to the image plane SI), expressed in millimeters.

FNO: the ratio of the effective focal length to the entrance pupil diameter of the camera optical lens.

The technical solutions of the present disclosure will be specifically described through six embodiments.

### Embodiment 1

The first prism P1 has a positive refractive power, with its object side surface convex in the paraxial region and its image side surface concave in the paraxial region;

The first lens L1 has a negative refractive power, with its object side surface convex in the paraxial region and its image side surface concave in the paraxial region;

The second lens L2 has a positive refractive power, with its object side surface convex in the paraxial region and its image side surface convex in the paraxial region;

The third lens L3 has a negative refractive power, with its object side surface concave in the paraxial region and its image side surface concave in the paraxial region;

The fourth lens L4 has a positive refractive power, with its object side surface convex in the paraxial region and its image side surface concave in the paraxial region;

The fifth lens L5 has a negative refractive power, with its object side surface convex in the paraxial region and its image side surface concave in the paraxial region.

Table 1 shows the design data of the camera optical lens 10 according to the first embodiment of the present disclosure.

TABLE 1

| | R | d | | nd | | νd | |
|---|---|---|---|---|---|---|---|
| S1 | ∞ | d0 | −9.763 | | | | |
| Rp1 | 29.676 | dp1 | 9.400 | nd1 | 1.8052 | v1 | 40.91 |
| Rp2 | 89.941 | dp2 | 0.100 | | | | |
| R1 | 4.888 | d1 | 0.600 | nd2 | 1.6400 | v2 | 23.54 |
| R2 | 3.483 | d2 | d2 | | | | |
| R3 | 7.036 | d3 | 2.874 | nd3 | 1.5444 | v3 | 55.82 |
| R4 | −7.039 | d4 | 0.266 | | | | |
| R5 | −6.521 | d5 | 0.947 | nd4 | 1.6153 | v4 | 25.94 |
| R6 | 25.398 | d6 | 0.185 | | | | |
| R7 | 8.640 | d7 | 0.800 | nd5 | 1.6700 | v5 | 19.39 |
| R8 | 19.761 | d8 | 0.100 | | | | |
| R9 | 2.134 | d9 | 0.707 | nd6 | 1.5346 | v6 | 55.69 |
| R10 | 1.886 | d10 | d10 | | | | |
| R11 | ∞ | d11 | 0.210 | ndg | 1.5168 | vg | 64.17 |
| R12 | ∞ | d12 | 2.832 | | | | |

Table 2 shows data of related optical parameters for the camera optical lens 10 according to the first embodiment of the present disclosure in a first state and a second state, respectively.

TABLE 2

| | First state | Second state |
|---|---|---|
| f | 16.716 | 17.579 |
| FOV | 24.00° | 20.26° |
| FNO | 2.09 | 2.20 |
| dp2 | 2.170 | 0.340 |
| d10 | 9.402 | 11.232 |

In which, the meaning of the various symbols is as follows.
S1: Aperture;
R: The curvature radius at the center of the optical surface;
Rp1: The central curvature radius of the object side surface of the first prism P1;
Rp2: The central curvature radius of the image side surface of the first prism P1;
R1: The central curvature radius of the object side surface of the first lens L1;
R2: The central curvature radius of the image side surface of the first lens L1;
R3: The central curvature radius of the object side surface of the second lens L2;
R4: The central curvature radius of the image side surface of the second lens L2;
R5: The central curvature radius of the object side surface of the third lens L3;
R6: The central curvature radius of the image side surface of the third lens L3;
R7: The central curvature radius of the object side surface of the fourth lens L4;
R8: The central curvature radius of the image side surface of the fourth lens L4;
R9: The central curvature radius of the object side surface of the fifth lens L5;
R10: The central curvature radius of the image side surface of the fifth lens L5;
R11: The central curvature radius of the object side surface of the optical filter GF;
R12: The central curvature radius of the image side surface of the optical filter GF;
d: The thickness on-axis of the lens and the distance on-axis between the lens;
d0: The distance on-axis from aperture S1 to the object side surface of the first prism P1;
dp1: The sum of the distance on-axis from the object side surface of the first prism P1 to the reflective surface, and the distance on-axis from the reflective surface to the image side surface of the first prism P1;
dp2: The distance on-axis from the image side surface of the first prism P1 to the object side surface of the first lens L1;
d1: The thickness on-axis of the first lens L1;
d2: The distance on-axis from the image side surface of the first lens L1 to the object side surface of the second lens L2;
d3: The thickness on-axis of the second lens L2;
d4: The distance on-axis from the image side surface of the second lens L2 to the object side surface of the third lens L3;
d5: The thickness on-axis of the third lens L3;
d6: The distance on-axis from the image side surface of the third lens L3 to the object side surface of the fourth lens L4;
d7: The thickness on-axis of the fourth lens L4;
d8: The distance on-axis from the image side surface of the fourth lens L4 to the object side surface of the fifth lens L5;
d9: The thickness on-axis of the fifth lens L5;
d10: The distance on-axis from the image side surface of the fifth lens L5 to the object side surface of the optical filter GF;
d11: The thickness on-axis of the optical filter GF;
d12: The distance on-axis from the image side surface of the optical filter GF to the image plane SI;
nd: The refractive power of the d line;
nd1: The refractive power of the d line of the first prism P1;
nd2: The refractive power of the d line of the first lens L1;
nd3: The refractive power of the d line of the second lens L2;
nd4: The refractive power of the d line of the third lens L3;
nd5: The refractive power of the d line of the fourth lens L4;
nd6: The refractive power of the d line of the fifth lens L5;
ndg: The refractive power of the d line of the optical filter GF;
vd: The abbe number;
v1: The abbe number of the first prism P1;
v2: The abbe number of the first lens L1;
v3: The abbe number of the second lens L2;
v4: The abbe number of the third lens L3;
v5: The abbe number of the fourth lens L4;
V6: The abbe number of the fifth lens L5;
vg: The abbe number of the optical filter GF.

Table 3 shows the aspherical surface data of each lens in the camera optical lens 10 in the embodiment 1 of the present disclosure.

TABLE 3

| | Conic Index | Aspherical Surface Index | | | | |
|---|---|---|---|---|---|---|
| | k | A4 | A6 | A8 | A10 | A12 |
| Rp1 | −2.73314E+01 | 4.96230E−05 | −3.14920E−06 | −7.93240E−08 | 1.42360E−08 | −1.97070E−10 |
| Rp2 | 0.00000E+00 | 0.00000E+00 | 0.00000E+00 | 0.00000E+00 | 0.00000E+00 | 0.00000E+00 |
| R1 | −3.23759E+00 | −3.56450E−03 | 1.65370E−04 | 4.22730E−05 | −2.44450E−05 | 7.07110E−06 |
| R2 | −5.09865E−01 | −9.01110E−03 | 6.00770E−04 | −1.01490E−04 | 1.98650E−05 | −2.25290E−06 |
| R3 | −6.29235E+00 | 1.99670E−03 | 1.04610E−04 | −5.49410E−05 | 1.31650E−05 | −2.02330E−06 |
| R4 | −2.13495E+00 | −9.71550E−03 | 4.02880E−03 | −8.67230E−04 | 1.22640E−04 | −1.20910E−05 |
| R5 | −1.21752E+01 | −2.33630E−02 | 7.82970E−03 | −1.59010E−03 | 2.09410E−04 | −1.81860E−05 |
| R6 | 3.73346E+01 | −1.83670E−02 | 4.24450E−03 | −5.81240E−04 | 1.24250E−05 | 9.23370E−06 |
| R7 | 4.58696E+00 | 1.03160E−02 | −3.42180E−03 | 1.39550E−03 | −4.19960E−04 | 7.40440E−05 |
| R8 | 3.32110E+01 | 9.10350E−03 | −8.83240E−04 | 1.07590E−03 | −5.88860E−04 | 1.42730E−04 |
| R9 | −1.84546E+00 | −1.40200E−02 | −1.07660E−03 | 2.18660E−03 | −9.97520E−04 | 2.33750E−04 |
| R10 | −7.84965E−01 | −2.19910E−02 | −3.87770E−03 | 3.28690E−03 | −1.27090E−03 | 2.95710E−04 |
| | Conic Index | Aspherical Surface Index | | | | |
| | k | A14 | A16 | A18 | A20 | A22 |
| Rp1 | −2.73314E+01 | −7.75500E−11 | 6.82230E−12 | −2.49240E−13 | 3.59720E−15 | 0.00000E+00 |
| Rp2 | 0.00000E+00 | 0.00000E+00 | 0.00000E+00 | 0.00000E+00 | 0.00000E+00 | 0.00000E+00 |
| R1 | −3.23759E+00 | −1.21030E−06 | 1.25610E−07 | −7.77430E−09 | 2.64340E−10 | −3.80460E−12 |
| R2 | −5.09865E−01 | 6.12130E−08 | 1.40320E−08 | −1.67450E−09 | 7.47180E−11 | −1.23740E−12 |
| R3 | −6.29235E+00 | 2.04120E−07 | −1.29480E−08 | 4.66920E−10 | −7.37530E−12 | 0.00000E+00 |
| R4 | −2.13495E+00 | 8.50760E−07 | −4.07330E−08 | 1.15830E−09 | −1.44340E−11 | 0.00000E+00 |
| R5 | −1.21752E+01 | 1.04990E−06 | −3.91230E−08 | 8.48780E−10 | −7.94640E−12 | 0.00000E+00 |
| R6 | 3.73346E+01 | −1.56800E−06 | 1.20980E−07 | −4.74130E−09 | 7.65100E−11 | 0.00000E+00 |
| R7 | 4.58696E+00 | −7.82250E−06 | 4.85810E−07 | −1.62140E−08 | 2.22430E−10 | 0.00000E+00 |
| R8 | 3.32110E+01 | −1.90970E−05 | 1.46820E−06 | −6.10040E−08 | 1.06810E−09 | 0.00000E+00 |
| R9 | −1.84546E+00 | −3.12580E−05 | 2.41230E−06 | −1.00210E−07 | 1.74050E−09 | 0.00000E+00 |
| R10 | −7.84965E−01 | −4.21910E−05 | 3.60470E−06 | −1.69590E−07 | 3.38690E−09 | 0.00000E+00 |

For convenience, the aspheric surface of each lens surface uses the aspheric surfaces shown in the following condition (1). However, the present disclosure is not limited to the aspherical polynomials form shown in the condition (1).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} \qquad ( 1 )$$

Among them, K is a conic index, A4, A6, A8, A10, A12, A14, A16, A18, A20, A22 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

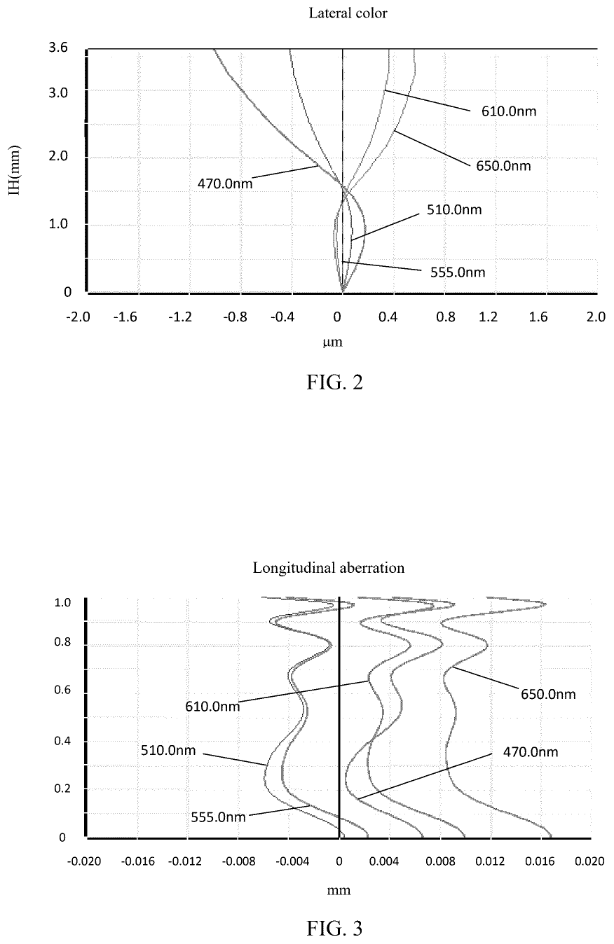

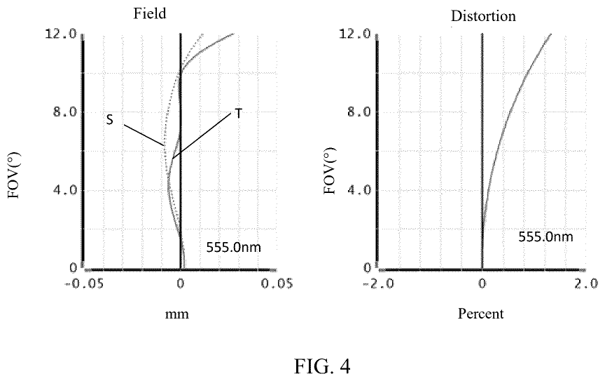

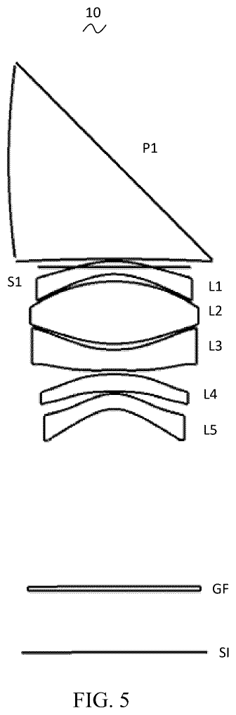

FIG. 2 and FIG. 3 show the longitudinal aberration and lateral color schematic diagrams after light with a wavelength of 650 nm, 610 nm, 555 nm, 510 nm and 470 nm passes the camera optical lens 10 of the first embodiment in the first state. FIG. 4 shows the field curvature and distortion schematic diagrams after light with a wavelength of 555 nm passes the camera optical lens 10 of the first embodiment in the first state, the field curvature S in FIG. 4 is a field curvature in the sagittal direction, T is a field curvature in the meridian direction.

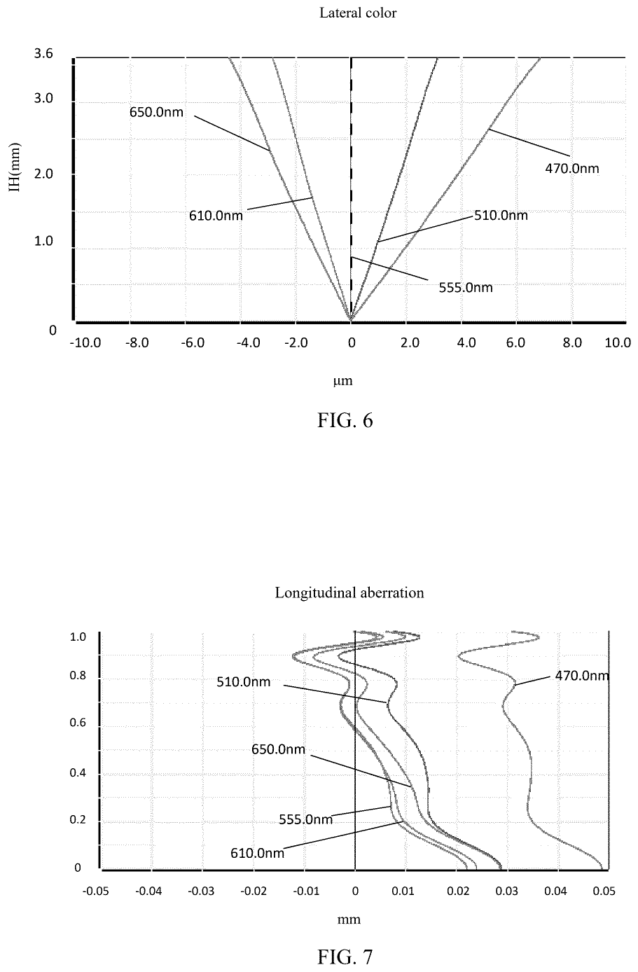

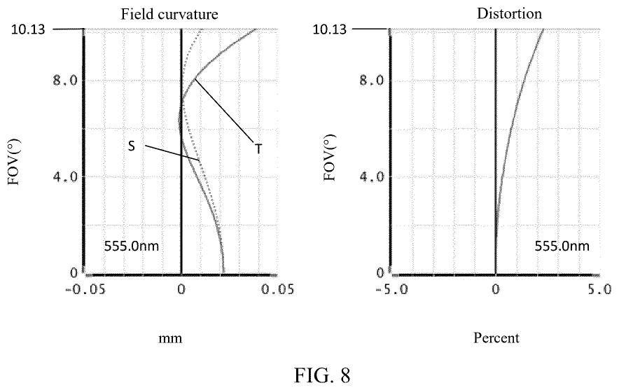

FIG. 6 and FIG. 7 show the longitudinal aberration and lateral color schematic diagrams after light with a wavelength of 650 nm, 610 nm, 555 nm, 510 nm and 470 nm passes the camera optical lens 10 of the first embodiment in the second state. FIG. 8 shows the field curvature and distortion schematic diagrams after light with a wavelength of 555 nm passes the camera optical lens 10 of the first embodiment in the second state, the field curvature S in FIG. 8 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the first embodiment satisfies all conditional expressions.

In this embodiment, the distance on-axis from the object side surface to the reflective surface of the first prism P1 is 4.900 mm, and the distance on-axis from the reflective surface to the image side surface of the first prism P1 is 4.500 mm.

In the first state, the entrance pupil diameter (ENPD) of the camera optical lens 10 is 8.000 mm, the full field image height (IH) is 3.600 mm, and the field of view (FOV) in the diagonal direction is 24.00°. The camera optical lens 10 satisfies the design requirements of a large aperture, long focal length, and miniaturization, with axial and off-axis chromatic aberrations sufficiently corrected, and exhibits superior optical characteristics.

### Embodiment 2

Embodiment 2 is basically the same as embodiment 1, the meaning of its symbols is the same as that of embodiment 1. Only differences are listed below. The object side surface of the first prism P1 is concave in the paraxial region, and the image side surface of the first prism P1 is convex in the paraxial region. The first prism P1 has a negative optical power, and the fifth lens L5 has a positive optical power.

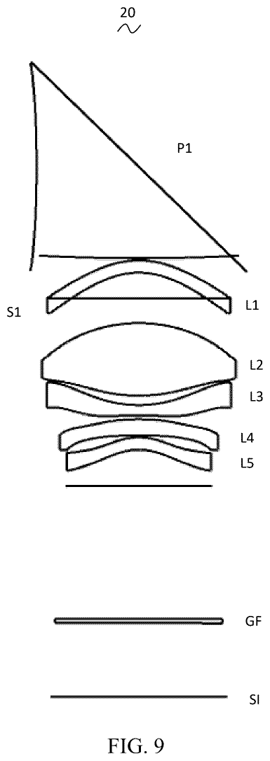

FIG. 9 shows a schematic structural diagram of the camera optical lens 20 according to the second embodiment of the present disclosure in the first state.

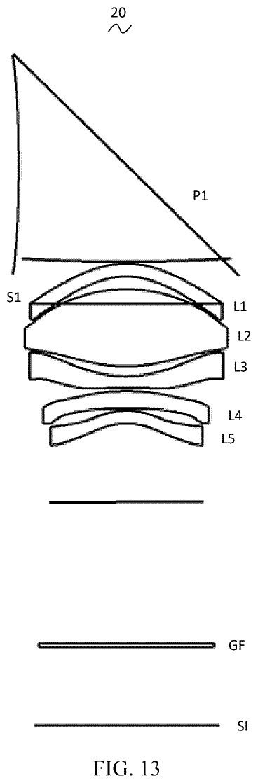

FIG. 13 shows a schematic structural diagram of the camera optical lens 20 according to the second embodiment of the present disclosure in the second state.

Table 4 present the design data of the camera optical lens 20 according to the second embodiment of the present disclosure.

TABLE 4

| | R | d | | nd | | νd | |
|---|---|---|---|---|---|---|---|
| S1 | ∞ | d0 | −11.359 | | | | |
| Rp1 | −59.269 | dp1 | 9.400 | nd1 | 1.8052 | v1 | 40.91 |
| Rp2 | −85.887 | dp2 | 0.100 | | | | |
| R1 | 4.064 | d1 | 0.600 | nd2 | 1.6400 | v2 | 23.54 |
| R2 | 3.506 | d2 | d2 | | | | |
| R3 | 6.692 | d3 | 3.578 | nd3 | 1.5444 | v3 | 55.82 |
| R4 | −9.185 | d4 | 0.465 | | | | |
| R5 | −6.659 | d5 | 0.516 | nd4 | 1.6153 | v4 | 25.94 |
| R6 | 26.031 | d6 | 0.185 | | | | |
| R7 | 10.650 | d7 | 0.800 | nd5 | 1.6700 | v5 | 19.39 |
| R8 | 22.462 | d8 | 0.100 | | | | |
| R9 | 3.027 | d9 | 0.600 | nd6 | 1.5346 | v6 | 55.69 |
| R10 | 2.914 | d10 | d10 | | | | |
| R11 | ∞ | d11 | 0.210 | ndg | 1.5168 | vg | 64.17 |
| R12 | ∞ | d12 | 3.635 | | | | |

Table 5 shows data of related optical parameters for the camera optical lens 20 according to the second embodiment of the present disclosure in a first state and a second state, respectively.

TABLE 5

| | First state | Second state |
|---|---|---|
| f | 16.922 | 17.772 |
| FOV | 24.00° | 20.68° |
| FNO | 2.12 | 2.22 |
| dp2 | 2.481 | 0.594 |
| d10 | 12.176 | 14.063 |

Table 6 shows the aspherical surface data of each lens in the camera optical lens 20 in the embodiment 2 of the present disclosure.

TABLE 6

| | Conic Index | Aspherical Surface Index | | | | |
|---|---|---|---|---|---|---|
| | k | A4 | A6 | A8 | A10 | A12 |
| Rp1 | 3.48217E+01 | −5.56210E−05 | 1.33990E−05 | −5.26870E−06 | 9.96890E−07 | −1.12060E−07 |
| Rp2 | 0.00000E+00 | 0.00000E+00 | 0.00000E+00 | 0.00000E+00 | 0.00000E+00 | 0.00000E+00 |
| R1 | −1.96445E+00 | −3.30460E−04 | 2.59020E−04 | −1.66910E−04 | 5.77670E−05 | −1.27590E−05 |
| R2 | −4.84281E−01 | −4.35360E−03 | 4.90490E−04 | −2.85250E−04 | 1.01080E−04 | −2.35560E−05 |
| R3 | −4.26702E+00 | 1.32530E−03 | 1.78820E−05 | −1.85660E−06 | 6.65370E−07 | −1.46650E−07 |
| R4 | −1.44037E+00 | −1.27640E−02 | 4.88630E−03 | −9.26620E−04 | 1.07910E−04 | −8.29780E−06 |
| R5 | −1.51328E+01 | −2.43670E−02 | 9.71570E−03 | −2.30140E−03 | 3.32490E−04 | −3.00760E−05 |
| R6 | 3.62607E+01 | 1.62630E−03 | −1.63770E−03 | −1.18360E−04 | 8.47820E−05 | −1.24440E−05 |
| R7 | 6.68475E+00 | 3.16490E−03 | 5.41510E−04 | −6.75330E−04 | 1.84710E−04 | −2.99590E−05 |
| R8 | 3.99165E+01 | −8.13720E−03 | 6.17860E−03 | −1.73290E−03 | 3.33020E−04 | −5.44210E−05 |
| R9 | −1.44346E+00 | 3.73160E−03 | −6.10840E−03 | 1.59610E−03 | −3.29750E−04 | 4.78120E−05 |
| R10 | −6.10306E−01 | 9.40450E−03 | −1.10290E−02 | 3.25680E−03 | −7.15220E−04 | 1.18510E−04 |

| | Conic Index | Aspherical Surface Index | | | | |
|---|---|---|---|---|---|---|
| | k | A14 | A16 | A18 | A20 | A22 |
| Rp1 | 3.48217E+01 | 7.78140E−09 | −3.26920E−10 | 7.61370E−12 | −7.54250E−14 | 0.00000E+00 |
| Rp2 | 0.00000E+00 | 0.00000E+00 | 0.00000E+00 | 0.00000E+00 | 0.00000E+00 | 0.00000E+00 |
| R1 | −1.96445E+00 | 1.88860E−06 | −1.90340E−07 | 1.30690E−08 | −6.01060E−10 | 1.77100E−11 |
| R2 | −4.84281E−01 | 3.72200E−06 | 4.03840E−07 | 3.00320E−08 | −1.50270E−09 | 4.83270E−11 |
| R3 | −4.26702E+00 | 1.39570E−08 | −6.43450E−10 | 1.45700E−11 | −1.39010E−13 | 0.00000E+00 |
| R4 | −1.44037E+00 | 4.38610E−07 | −1.55540E−08 | 3.29320E−10 | −3.08380E−12 | 0.00000E+00 |
| R5 | −1.51328E+01 | 1.71780E−06 | −6.01510E−08 | 1.17650E−09 | −9.80230E−12 | 0.00000E+00 |
| R6 | 3.62607E+01 | 9.23000E−07 | −3.81860E−08 | 8.41630E−10 | −7.75480E−12 | 0.00000E+00 |
| R7 | 6.68475E+00 | 3.09960E−06 | −1.95710E−07 | 6.84880E−09 | −1.02680E−10 | 0.00000E+00 |
| R8 | 3.99165E+01 | 6.78370E−06 | −5.39240E−07 | 2.38680E−08 | −4.53140E−10 | 0.00000E+00 |
| R9 | −1.44346E+00 | −3.83300E−06 | 1.21640E−07 | 1.84940E−09 | −1.50810E−10 | 0.00000E+00 |
| R10 | −6.10306E−01 | −1.33590E−05 | 9.34520E−07 | −3.63140E−08 | 5.98220E−10 | 0.00000E+00 |

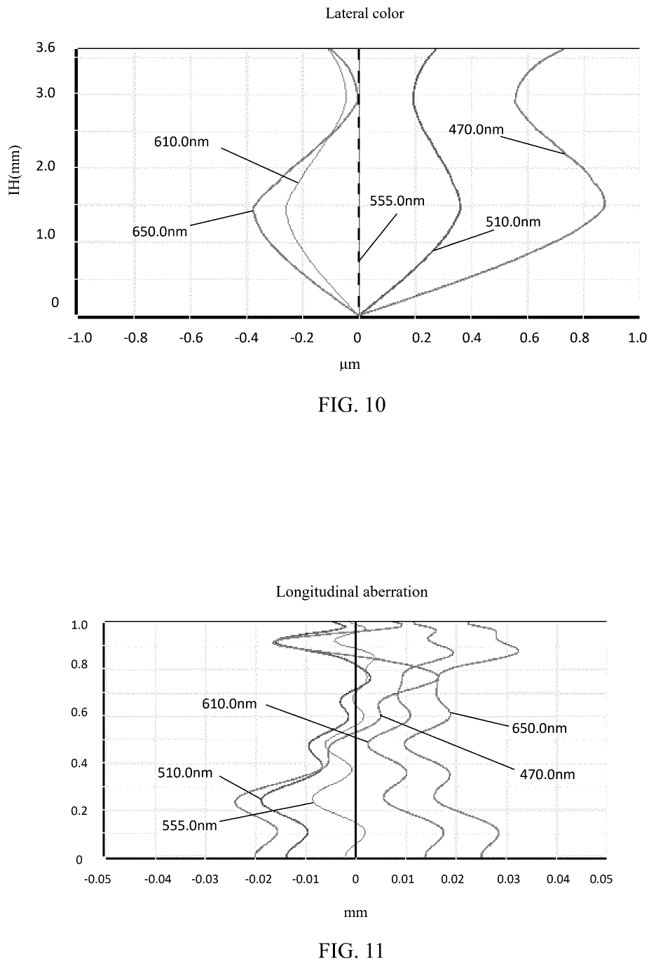

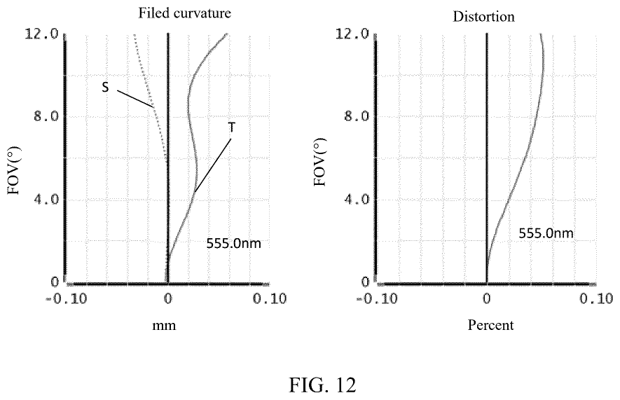

FIG. 10 and FIG. 11 show the longitudinal aberration and lateral color schematic diagrams after light with a wavelength of 650 nm, 610 nm, 555 nm, 510 nm and 470 nm passes the camera optical lens 20 of the second embodiment in the first state. FIG. 12 shows the field curvature and distortion schematic diagrams after light with a wavelength of 555 nm passes the camera optical lens 20 of the second embodiment in the first state, the field curvature S in FIG. 12 is a field curvature in the sagittal direction, T is a field curvature in the meridian direction.

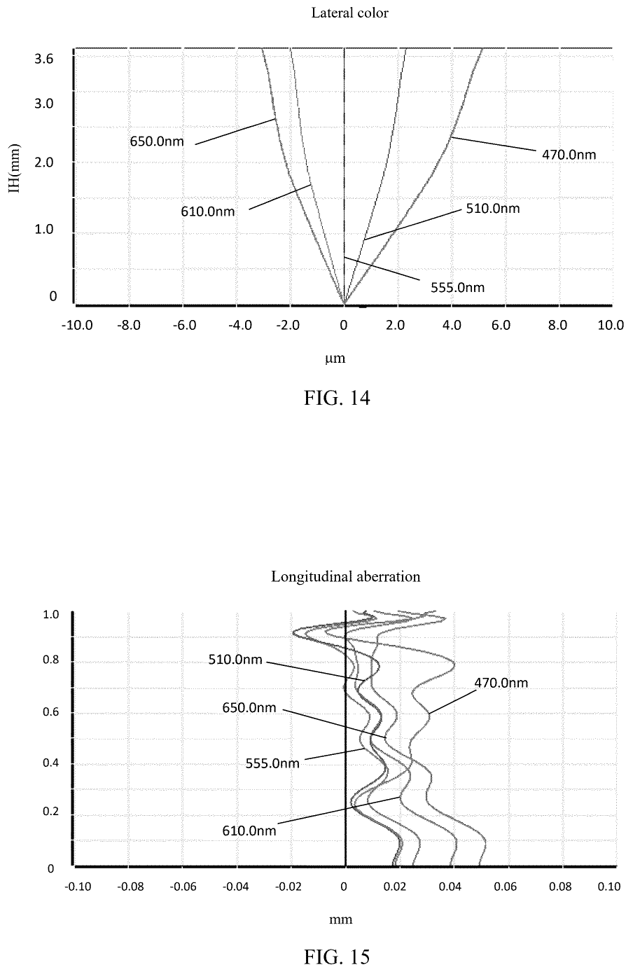

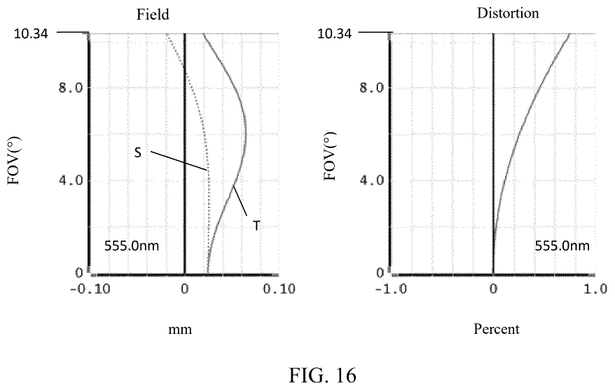

FIG. 14 and FIG. 15 show the longitudinal aberration and lateral color schematic diagrams after light with a wavelength of 650 nm, 610 nm, 555 nm, 510 nm and 470 nm passes the camera optical lens 20 of the second embodiment in the second state. FIG. 16 shows the field curvature and distortion schematic diagrams after light with a wavelength of 555 nm passes the camera optical lens 20 of the second embodiment in the second state, the field curvature S in FIG. 16 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the second embodiment satisfies all conditional expressions.

In this embodiment, the distance on-axis from the object side surface to the reflective surface of the first prism P1 is 4.900 mm, and the distance on-axis from the reflective surface to the image side surface is of the first prism P1 4.500 mm.

In the first state, the entrance pupil diameter (ENPD) of the camera optical lens 20 is 8.000 mm, the full field image height (IH) is 3.600 mm, and the field of view (FOV) in the diagonal direction is 24.00°. The camera optical lens 20 satisfies the design requirements of a large aperture, long focal length, and miniaturization, with axial and off-axis chromatic aberrations sufficiently corrected, and exhibits superior optical characteristics.

### Embodiment 3

Embodiment 3 is basically the same as embodiment 1, the meaning of its symbols is the same as that of embodiment 1. Only differences are listed below. The fifth lens L5 has a positive refractive power.

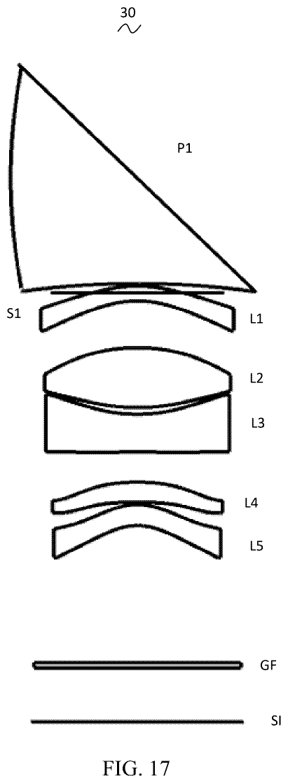

FIG. 17 shows a schematic structural diagram of the camera optical lens 30 according to the third embodiment of the present disclosure in the first state.

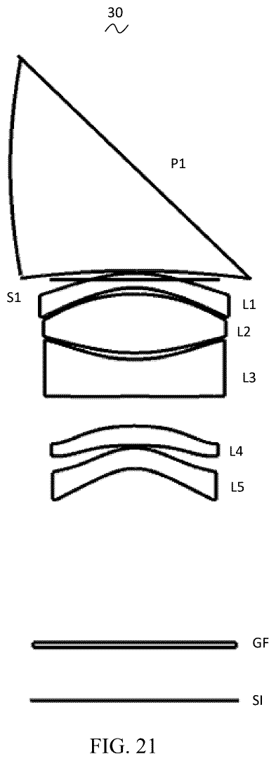

FIG. 21 shows a schematic structural diagram of the camera optical lens 30 according to the third embodiment of the present disclosure in the second state.

Table 7 present the design data of the camera optical lens 30 according to the third embodiment of the present disclosure.

TABLE 7

| | R | d | | nd | | νd | |
|---|---|---|---|---|---|---|---|
| S1 | ∞ | d0 | −9.758 | | | | |
| Rp1 | 22.619 | dp1 | 9.400 | nd1 | 1.8052 | v1 | 40.91 |
| Rp2 | 32.176 | dp2 | 0.100 | | | | |
| R1 | 4.992 | d1 | 0.600 | nd2 | 1.6400 | v2 | 23.54 |
| R2 | 3.792 | d2 | d2 | | | | |
| R3 | 6.517 | d3 | 2.412 | nd3 | 1.5444 | v3 | 55.82 |
| R4 | −8.981 | d4 | 0.269 | | | | |
| R5 | −8.015 | d5 | 1.514 | nd4 | 1.6153 | v4 | 25.94 |
| R6 | 15.325 | d6 | 1.228 | | | | |
| R7 | 8.524 | d7 | 0.800 | nd5 | 1.6700 | v5 | 19.39 |
| R8 | 16.481 | d8 | 0.100 | | | | |
| R9 | 2.236 | d9 | 0.846 | nd6 | 1.5346 | v6 | 55.69 |
| R10 | 2.068 | d10 | d10 | | | | |
| R11 | ∞ | d11 | 0.210 | ndg | 1.5168 | vg | 64.17 |
| R12 | ∞ | d12 | 2.185 | | | | |

Table 8 shows data of related optical parameters for the camera optical lens 30 according to the third embodiment of the present disclosure in a first state and a second state, respectively.

TABLE 8

| | First state | Second state |
|---|---|---|
| f | 16.661 | 17.099 |
| FOV | 24.00° | 20.86° |
| FNO | 2.08 | 2.14 |
| dp2 | 1.880 | 0.259 |
| d10 | 7.916 | 9.537 |

Table 9 shows the aspherical surface data of each lens in the camera optical lens 30 in the embodiment 3 of the present disclosure.

TABLE 9

| | Conic Index | Aspherical Surface Index | | | | |
|---|---|---|---|---|---|---|
| | k | A4 | A6 | A8 | A10 | A12 |
| Rp1 | −8.49102E+00 | 3.16840E−05 | 6.03010E−06 | −1.92280E−06 | 2.84580E−07 | −2.53000E−08 |
| Rp2 | 0.00000E+00 | 0.00000E+00 | 0.00000E+00 | 0.00000E+00 | 0.00000E+00 | 0.00000E+00 |
| R1 | −2.66652E+00 | −2.76820E−03 | 1.84530E−04 | −3.64660E−05 | 1.38670E−05 | −3.71970E−06 |
| R2 | −4.25275E−01 | −6.86810E−03 | 4.15190E−04 | −1.17210E−04 | 4.07700E−05 | −1.01670E−05 |
| R3 | −6.43853E+00 | 2.83910E−03 | 1.01100E−04 | −9.59600E−05 | 2.85260E−05 | −5.15060E−06 |
| R4 | 3.45597E+00 | −1.33560E−02 | 7.59070E−03 | −2.29930E−03 | 4.96260E−04 | −7.67230E−05 |
| R5 | −2.08991E+01 | −2.91930E−02 | 1.25090E−02 | −3.52910E−03 | 7.10500E−04 | −1.02660E−04 |
| R6 | 1.65481E+01 | −1.82710E−02 | 6.04070E−03 | −1.53010E−03 | 2.75180E−04 | −3.59550E−05 |
| R7 | 5.17706E+00 | 1.07160E−02 | −3.74760E−03 | 1.56960E−03 | −4.76990E−04 | 8.74700E−05 |
| R8 | 2.16992E+01 | 8.77340E−03 | −2.15400E−03 | 1.67040E−03 | −7.38080E−04 | 1.71570E−04 |
| R9 | −1.61038E+00 | −1.74360E−02 | 1.40630E−03 | 1.12450E−03 | −7.30180E−04 | 2.03550E−04 |
| R10 | −7.39140E−01 | −2.64020E−02 | 1.37540E−03 | 7.54900E−04 | −4.96520E−04 | 1.46410E−04 |

| | Conic Index | Aspherical Surface Index | | | | |
|---|---|---|---|---|---|---|
| | k | A14 | A16 | A18 | A20 | A22 |
| Rp1 | −8.49102E+00 | 1.38420E−09 | −4.53550E−11 | 8.10810E−13 | −6.01490E−15 | 0.00000E+00 |
| Rp2 | 0.00000E+00 | 0.00000E+00 | 0.00000E+00 | 0.00000E+00 | 0.00000E+00 | 0.00000E+00 |
| R1 | −2.66652E+00 | 6.78110E−07 | −8.17850E−08 | 6.15120E−09 | −2.58750E−10 | 4.62070E−12 |
| R2 | −4.25275E−01 | 1.74920E−06 | −2.03680E−07 | 1.51750E−08 | −6.46380E−10 | 1.18850E−11 |
| R3 | −6.43853E+00 | 5.91050E−07 | −4.19880E−08 | 1.67280E−09 | −2.85870E−11 | 0.00000E+00 |
| R4 | 3.45597E+00 | 8.14450E−06 | −5.53100E−07 | 2.13730E−08 | −3.54980E−10 | 0.00000E+00 |
| R5 | −2.08991E+01 | 1.03300E−05 | −6.77240E−07 | 2.56700E−08 | −4.23060E−10 | 0.00000E+00 |
| R6 | 1.65481E+01 | 3.40640E−06 | −2.21140E−07 | 8.66020E−09 | −1.52520E−10 | 0.00000E+00 |
| R7 | 5.17706E+00 | −1.00230E−05 | 6.98190E−07 | −2.65890E−08 | 4.09250E−10 | 0.00000E+00 |
| R8 | 2.16992E+01 | −2.38120E−05 | 1.99140E−06 | −9.23780E−08 | 1.81760E−09 | 0.00000E+00 |
| R9 | −1.61038E+00 | −3.20850E−05 | 2.95650E−06 | −1.48310E−07 | 3.12490E−09 | 0.00000E+00 |
| R10 | −7.39140E−01 | −2.48820E−05 | 2.48610E−06 | −1.35690E−07 | 3.12090E−09 | 0.00000E+00 |

| | |
|---|---|
| Conic Index | Aspherical Surface Index |

| | k | A24 | A26 |
|---|---|---|---|
| Rp1 | −8.49102E+00 | 0.00000E+00 | 0.00000E+00 |
| Rp2 | 0.00000E+00 | 0.00000E+00 | 0.00000E+00 |
| R1 | −2.66652E+00 | −3.02150E−13 | 2.27000E−15 |
| R2 | −4.25275E−01 | −9.02040E−13 | 7.42570E−15 |
| R3 | −6.43853E+00 | 0.00000E+00 | 0.00000E+00 |
| R4 | 3.45597E+00 | 0.00000E+00 | 0.00000E+00 |
| R5 | −2.08991E+01 | 0.00000E+00 | 0.00000E+00 |
| R6 | 1.65481E+01 | 0.00000E+00 | 0.00000E+00 |
| R7 | 5.17706E+00 | 0.00000E+00 | 0.00000E+00 |
| R8 | 2.16992E+01 | 0.00000E+00 | 0.00000E+00 |
| R9 | −1.61038E+00 | 0.00000E+00 | 0.00000E+00 |
| R10 | −7.39140E−01 | 0.00000E+00 | 0.00000E+00 |

In Embodiment 3 of the present disclosure, the aspheric surface of each lens surface uses the aspheric surfaces shown in the following condition (2).

$$z = ( c {r}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} \qquad ( 2 )$$

Among them, K is a conic index, A4, A6, A8, A10, A12, A14, A16, A18, A20, A22, A24, A26 are aspheric surface indexes, c is the curvature at the center of the optical surface, r is the vertical distance from the optical axis to a point on the aspheric curve, and z is the sagitta (i.e., the vertical distance between a point on the aspheric surface at distance r from the optical axis and a plane tangent to the vertex of the aspheric surface on the optical axis).

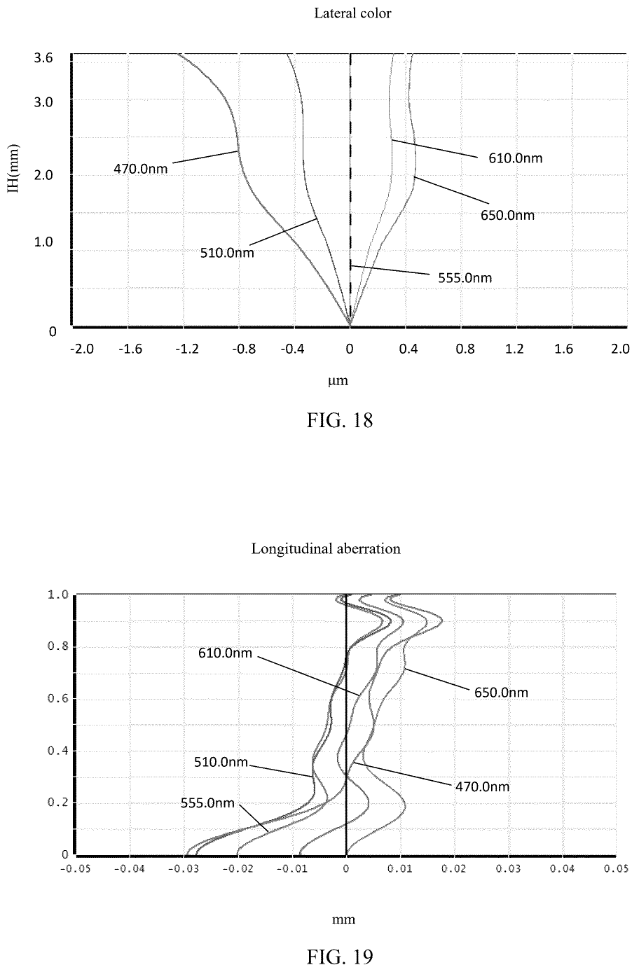

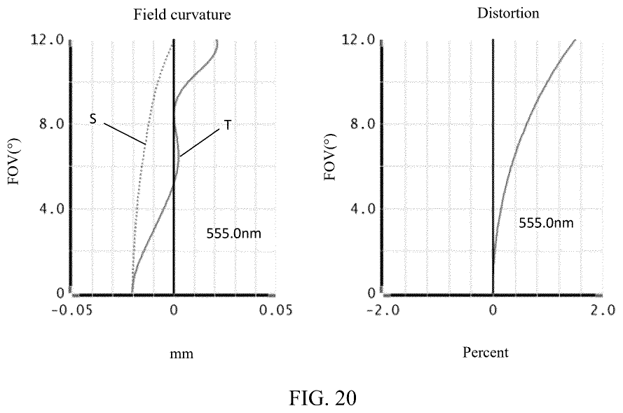

FIG. 18 and FIG. 19 show the longitudinal aberration and lateral color schematic diagrams after light with a wavelength of 650 nm, 610 nm, 555 nm, 510 nm and 470 nm passes the camera optical lens 30 of the third embodiment in the first state. FIG. 20 shows the field curvature and distortion schematic diagrams after light with a wavelength of 555 nm passes the camera optical lens 30 of the third embodiment in the first state, the field curvature S in FIG. 20 is a field curvature in the sagittal direction, T is a field curvature in the meridian direction.

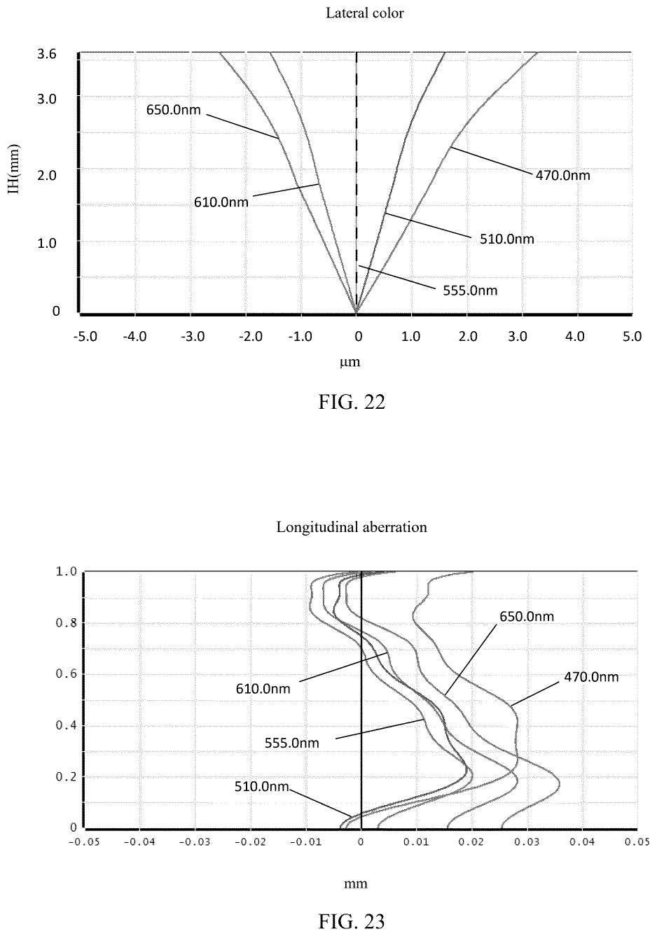

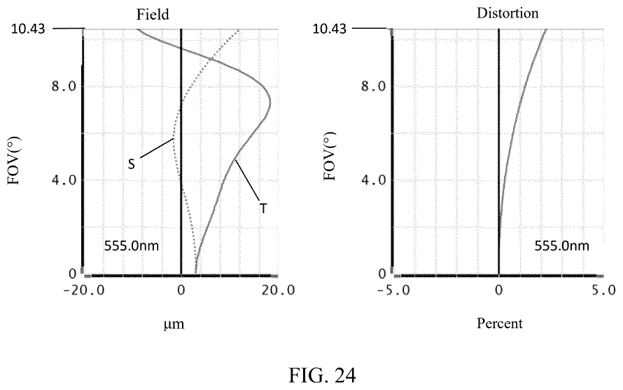

FIG. 22 and FIG. 23 show the longitudinal aberration and lateral color schematic diagrams after light with a wavelength of 650 nm, 610 nm, 555 nm, 510 nm and 470 nm passes the camera optical lens 30 of the third embodiment in the second state. FIG. 24 shows the field curvature and distortion schematic diagrams after light with a wavelength of 555 nm passes the camera optical lens 30 of the third embodiment in the second state, the field curvature S in FIG. 24 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the third embodiment satisfies all conditional expressions.

In this embodiment, the distance on-axis from the object side surface to the reflective surface of the first prism P1 is 4.900 mm, and the distance on-axis from the reflective surface to the image side surface of the first prism P1 is 4.500 mm.

In the first state, the entrance pupil diameter (ENPD) of the camera optical lens 30 is 8.000 mm, the full field image height (IH) is 3.600 mm, and the field of view (FOV) in the diagonal direction is 24.00°. The camera optical lens 30 satisfies the design requirements of a large aperture, long focal length, and miniaturization, with axial and off-axis chromatic aberrations sufficiently corrected, and exhibits superior optical characteristics.

### Embodiment 4

Embodiment 4 is basically the same as embodiment 1, the meaning of its symbols is the same as that of embodiment 1. Only differences are listed below. The image side surface of the first prism P1 is convex in the paraxial region.

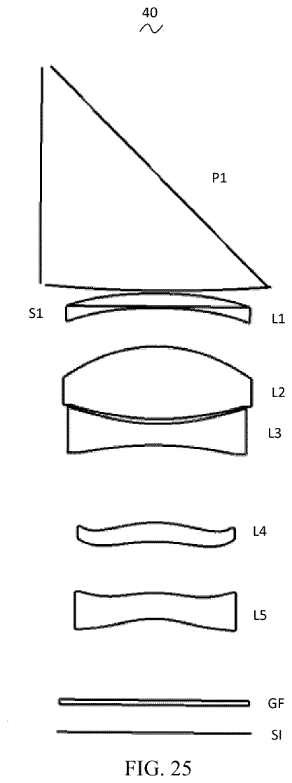

FIG. 25 shows a schematic structural diagram of the camera optical lens 40 according to the fourth embodiment of the present disclosure in the first state.

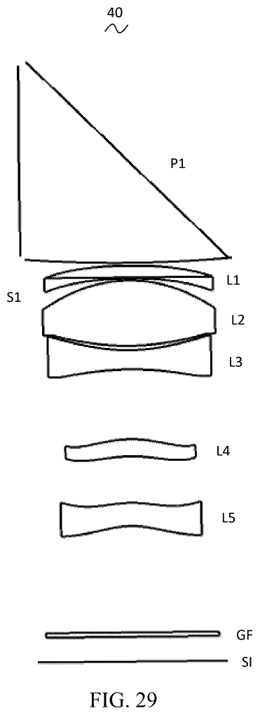

FIG. 29 shows a schematic structural diagram of the camera optical lens 40 according to the fourth embodiment of the present disclosure in the second state.

Table 10 present the design data of the camera optical lens 40 according to the fourth embodiment of the present disclosure.

TABLE 10

| | R | d | | nd | | νd | |
|---|---|---|---|---|---|---|---|
| S1 | ∞ | d0 | −10.479 | | | | |
| Rp1 | 232.677 | dp1 | 9.800 | nd1 | 1.8052 | v1 | 40.91 |
| Rp2 | −58.906 | dp2 | 0.131 | | | | |
| R1 | 19.137 | d1 | 0.600 | nd2 | 1.6400 | v2 | 23.54 |
| R2 | 15.593 | d2 | d2 | | | | |
| R3 | 6.210 | d3 | 3.056 | nd3 | 1.5444 | v3 | 55.82 |
| R4 | −10.648 | d4 | 0.206 | | | | |
| R5 | −8.452 | d5 | 0.889 | nd4 | 1.6153 | v4 | 25.94 |
| R6 | 12.446 | d6 | 3.270 | | | | |
| R7 | 5.196 | d7 | 0.800 | nd5 | 1.6700 | v5 | 19.39 |
| R8 | 6.330 | d8 | 2.164 | | | | |
| R9 | 5.256 | d9 | 1.088 | nd6 | 1.5346 | v6 | 55.69 |
| R10 | 3.911 | d10 | d10 | | | | |
| R11 | ∞ | d11 | 0.210 | ndg | 1.5168 | vg | 64.17 |
| R12 | ∞ | d12 | 1.165 | | | | |

Table 11 shows data of related optical parameters for the camera optical lens 40 according to the fourth embodiment of the present disclosure in a first state and a second state, respectively.

TABLE 11

| | First state | Second state |
|---|---|---|
| f | 16.682 | 16.473 |
| FOV | 24.00° | 21.73° |
| FNO | 2.09 | 2.06 |
| dp2 | 1.630 | 0.101 |
| d10 | 4.810 | 6.339 |

Table 12 shows the aspherical surface data of each lens in the camera optical lens 40 in the embodiment 4 of the present disclosure.

TABLE 12

| | Conic Index | Aspherical Surface Index | | | | |
|---|---|---|---|---|---|---|
| | k | A4 | A6 | A8 | A10 | A12 |
| Rp1 | 1.19339E+01 | −7.20160E−05 | 2.04660E−06 | −7.76430E−07 | 1.69950E−07 | −2.20920E−08 |
| Rp2 | 0.00000E+00 | 0.00000E+00 | 0.00000E+00 | 0.00000E+00 | 0.00000E+00 | 0.00000E+00 |
| R1 | 7.94568E+00 | 4.89780E−04 | −2.34560E−05 | 1.30000E−05 | −3.53930E−06 | 6.15670E−07 |
| R2 | 1.15905E+01 | 1.51170E−04 | −3.52670E−05 | 1.37550E−05 | −3.71170E−06 | 6.42290E−07 |
| R3 | −5.07838E+00 | 2.60370E−03 | −1.46740E−04 | 1.71320E−05 | −2.53240E−06 | 3.10670E−07 |
| R4 | −2.25186E+00 | −5.61030E−04 | 4.88200E−04 | −4.97640E−05 | −1.17120E−05 | 3.77960E−06 |
| R5 | −2.59045E+01 | −7.36950E−03 | 2.35530E−03 | −4.64900E−04 | 5.37750E−05 | −3.14500E−06 |
| R6 | 8.01974E+00 | −3.72910E−03 | 1.19260E−03 | −2.90660E−04 | 4.34310E−05 | −4.12550E−06 |
| R7 | 9.71196E−01 | −9.43110E−03 | 5.66340E−04 | −7.50860E−05 | −6.19660E−06 | 2.63080E−06 |
| R8 | 1.49138E+00 | −1.26480E−02 | 1.36930E−03 | −2.37360E−04 | 2.60790E−05 | −2.45980E−06 |
| R9 | −1.06614E+00 | −1.58420E−02 | 4.60900E−04 | 7.62410E−05 | −9.25780E−06 | −5.78430E−07 |
| R10 | −6.61183E−01 | −1.58050E−02 | 7.55130E−04 | 9.42480E−05 | −3.07760E−05 | 4.27970E−06 |

| | Conic Index | Aspherical Surface Index | | | | |
|---|---|---|---|---|---|---|
| | k | A14 | A16 | A18 | A20 | A22 |
| Rp1 | 1.19339E+01 | 1.74020E−09 | −8.14370E−11 | 2.08170E−12 | −2.23670E−14 | 0.00000E+00 |
| Rp2 | 0.00000E+00 | 0.00000E+00 | 0.00000E+00 | 0.00000E+00 | 10.00000E+00 | 0.00000E+00 |
| R1 | 7.94568E+00 | −7.10450E−08 | 5.39160E−09 | −2.57220E−10 | 6.96960E−12 | −8.16450E−14 |
| R2 | 1.15905E+01 | −7.63230E−08 | 6.09460E−09 | −3.10960E−10 | 9.11290E−12 | −1.16990E−13 |
| R3 | −5.07838E+00 | −2.75470E−08 | 1.60070E−09 | −5.38690E−11 | 7.72230E−13 | 0.00000E+00 |
| R4 | −2.25186E+00 | −4.60490E−07 | 2.95990E−08 | −9.98820E−10\| | 1.40480E−11 | 0.00000E+00 |
| R5 | −2.59045E+01 | 1.25300E−08 | 9.88220E−09 | −5.52200E−10 | 1.00110E−11 | 0.00000E+00 |
| R6 | 8.01974E+00 | 2.29000E−07 | −5.80700E−09 | −2.53960E−11 | 3.18370E−12 | 0.00000E+00 |
| R7 | 9.71196E−01 | −4.51580E−07 | 4.28470E−08 | −2.19120E−09 | 4.69550E−11 | 0.00000E+00 |
| R8 | 1.49138E+00 | 1.61220E−07 | −4.67130E−09 | −7.83490E−11 | 5.87680E−12 | 0.00000E+00 |
| R9 | −1.06614E+00 | 2.36730E−07 | −2.31300E−08 | 1.03470E−09 | −1.92030E−11 | 0.00000E+00 |
| R10 | −6.61183E−01 | −3.57730E−07 | 1.83230E−08 | −5.21710E−10 | 5.92330E−12 | 0.00000E+00 |

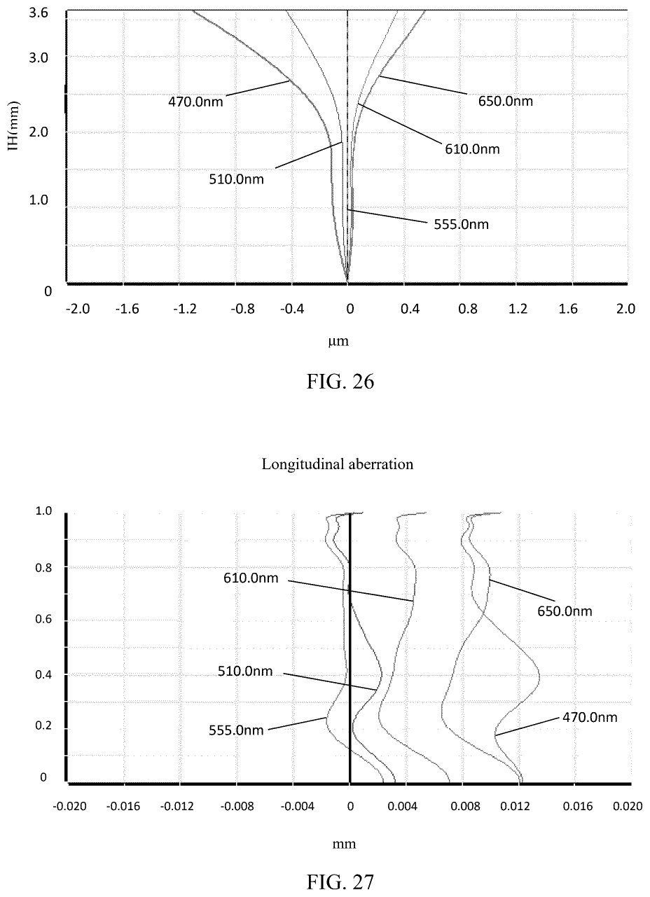

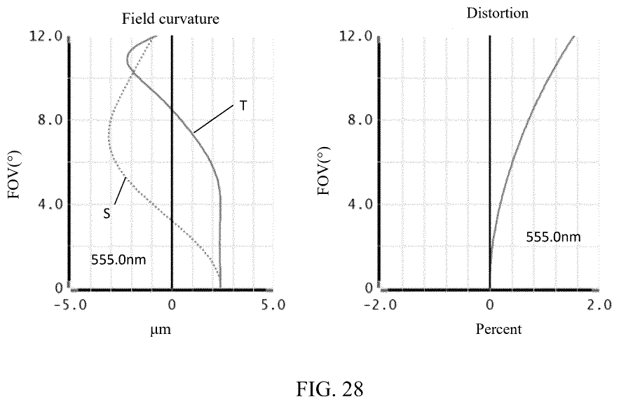

FIG. 26 and FIG. 27 show the longitudinal aberration and lateral color schematic diagrams after light with a wavelength of 650 nm, 610 nm, 555 nm, 510 nm and 470 nm passes the camera optical lens 40 of the fourth embodiment in the first state. FIG. 28 shows the field curvature and distortion schematic diagrams after light with a wavelength of 555 nm passes the camera optical lens 40 of the fourth embodiment in the first state, the field curvature S in FIG. 28 is a field curvature in the sagittal direction, T is a field curvature in the meridian direction.

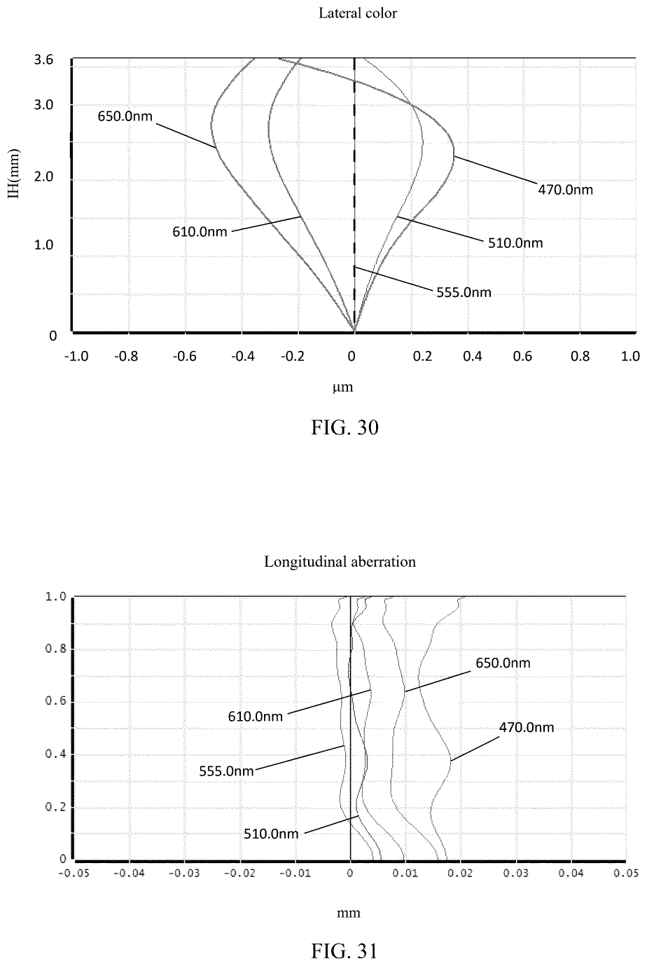

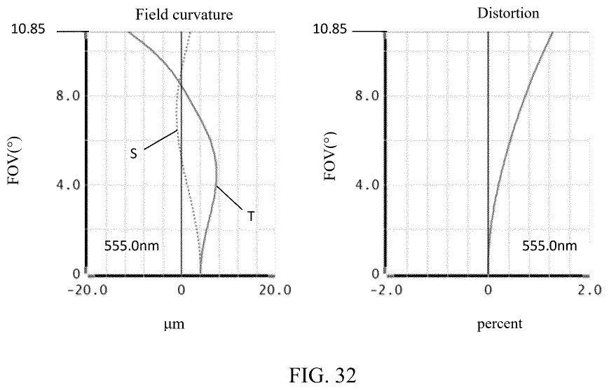

FIG. 30 and FIG. 31 show the longitudinal aberration and lateral color schematic diagrams after light with a wavelength of 650 nm, 610 nm, 555 nm, 510 nm and 470 nm passes the camera optical lens 40 of the fourth embodiment in the second state. FIG. 32 shows the field curvature and distortion schematic diagrams after light with a wavelength of 555 nm passes the camera optical lens 40 of the fourth embodiment in the second state, the field curvature S in FIG. 32 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the fourth embodiment satisfies all conditional expressions.

In this embodiment, the distance on-axis from the object side surface to the reflective surface of the first prism P1 is 5.000 mm, and the distance on-axis from the reflective surface to the image side surface of the first prism P1 is 4.800 mm.

In the first state, the entrance pupil diameter (ENPD) of the camera optical lens 40 is 8.000 mm, the full field image height (IH) is 3.600 mm, and the field of view (FOV) in the diagonal direction is 24.00°. The camera optical lens 40 satisfies the design requirements of a large aperture, long focal length, and miniaturization, with axial and off-axis chromatic aberrations sufficiently corrected, and exhibits superior optical characteristics.

### Embodiment 5

Embodiment 5 is basically the same as embodiment 1, the meaning of its symbols is the same as that of embodiment 1. Only differences are listed below. The image side surface of the first prism P1 is convex in the paraxial region.

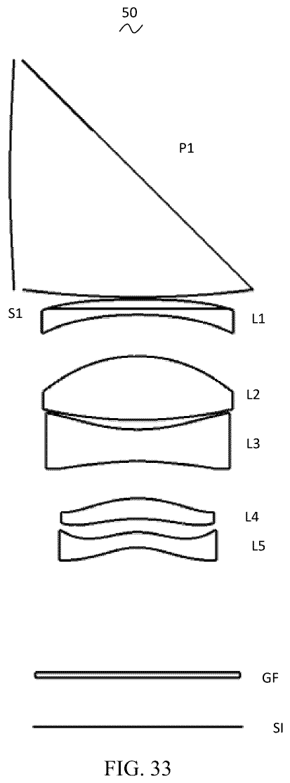

FIG. 33 shows a schematic structural diagram of the camera optical lens 50 according to the fifth embodiment of the present disclosure in the first state.

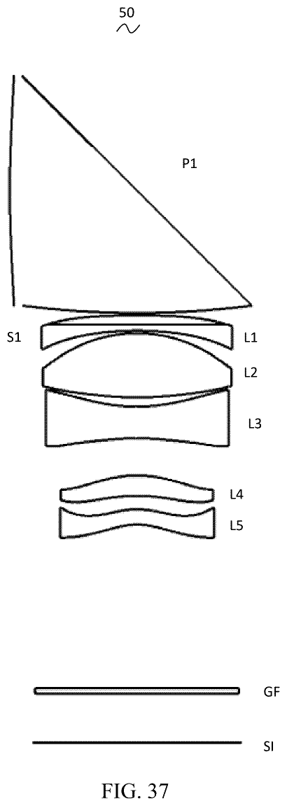

FIG. 37 shows a schematic structural diagram of the camera optical lens 50 according to the fifth embodiment of the present disclosure in the second state.

Table 13 present the design data of the camera optical lens 50 according to the fifth embodiment of the present disclosure.

TABLE 13

| | R | d | | nd | | νd | |
|---|---|---|---|---|---|---|---|
| S1 | ∞ | d0 | −10.256 | | | | |
| Rp1 | 44.382 | dp1 | 9.800 | nd1 | 1.8052 | v1 | 40.91 |
| Rp2 | −35.505 | dp2 | 0.100 | | | | |
| R1 | 44.690 | d1 | 0.600 | nd2 | 1.6400 | v2 | 23.54 |
| R2 | 13.989 | d2 | d2 | | | | |
| R3 | 5.516 | d3 | 2.518 | nd3 | 1.5444 | v3 | 55.82 |
| R4 | −13.295 | d4 | 0.358 | | | | |
| R5 | −7.694 | d5 | 1.246 | nd4 | 1.6153 | v4 | 25.94 |
| R6 | 8.751 | d6 | 1.462 | | | | |
| R7 | 4.535 | d7 | 0.800 | nd5 | 1.6700 | v5 | 19.39 |
| R8 | 6.426 | d8 | 0.529 | | | | |
| R9 | 3.033 | d9 | 0.600 | nd6 | 1.5346 | v6 | 55.69 |
| R10 | 2.680 | d10 | d10 | | | | |
| R11 | ∞ | d11 | 0.210 | ndg | 1.5168 | vg | 64.17 |
| R12 | ∞ | d12 | 1.922 | | | | |

Table 14 shows data of related optical parameters for the camera optical lens 50 according to the fifth embodiment of the present disclosure in a first state and a second state, respectively.

TABLE 14

| | First state | Second state |
|---|---|---|
| f | 16.672 | 17.423 |
| FOV | 24.00° | 21.76° |
| FNO | 2.08 | 2.18 |
| dp2 | 1.622 | 0.101 |
| d10 | 7.043 | 8.564 |

Table 15 shows the aspherical surface data of each lens in the camera optical lens 50 in the embodiment 5 of the present disclosure.

TABLE 15

| | |
|---|---|
| Conic Index | Aspherical Surface Index |

| | k | A4 | A6 | A8 | A10 | A12 |
|---|---|---|---|---|---|---|
| Rp1 | −2.61692E+01 | −1.12190E−04 | 2.35130E−06 | −1.04960E−06 | 2.15210E−07 | −2.65430E−08 |
| Rp2 | 0.00000E+00 | 0.00000E+00 | 0.00000E+00 | 0.00000E+00 | 0.00000E+00 | 0.00000E+00 |
| R1 | 5.60083E+01 | 1.76410E−03 | −8.76200E−05 | 1.27410E−05 | −2.70020E−06 | 4.58460E−07 |
| R2 | 1.05907E+01 | 1.16240E−03 | −6.25240E−05 | −7.75040E−06 | 3.64180E−06 | −8.56650E−07 |
| R3 | −3.88136E+00 | 3.08800E−03 | −7.91920E−05 | −6.11710E−06 | 3.61820E−06 | −7.20320E−07 |
| R4 | −3.21910E+00 | 3.36220E−04 | −1.72720E−05 | 5.97320E−05 | −1.41300E−05 | 1.09110E−06 |
| R5 | −2.20793E+01 | −9.51410E−03 | 2.16220E−03 | −2.09610E−04 | −9.31960E−06 | 5.49320E−06 |
| R6 | 4.88628E+00 | −1.08490E−02 | 1.59250E−03 | −4.46020E−05 | −5.61640E−05 | 1.61580E−05 |
| R7 | 7.52647E−01 | −4.75380E−03 | −9.49690E−04 | 2.91820E−04 | −8.08660E−05 | 1.02960E−05 |
| R8 | 1.88646E+00 | −8.26590E−03 | 8.24790E−04 | −1.29690E−04 | −2.90050E−05 | 5.97240E−06 |
| R9 | −5.01388E+00 | −1.56390E−02 | −1.75430E−03 | 1.24000E−03 | −3.63260E−04 | 5.89470E−05 |
| R10 | −1.84782E+00 | −2.31090E−02 | 1.01420E−03 | 7.74390E−04 | −3.32710E−04 | 7.64190E−05 |

| | Conic Index | Aspherical Surface Index | | | | |
|---|---|---|---|---|---|---|
| | k | A14 | A16 | A18 | A20 | A22 |
| Rp1 | −2.61692E+01 | 2.00680E−09 | −9.08790E−11 | 2.26090E−12 | −2.37390E−14 | 0.00000E+00 |
| Rp2 | 0.00000E+00 | 0.00000E+00 | 0.00000E+00 | 0.00000E+00 | 0.00000E+00 | 0.00000E+00 |
| R1 | 5.60083E+01 | −5.32260E−08 | 4.13590E−09 | −2.08640E−10 | 6.24070E−12 | −8.43310E−14 |
| R2 | 1.05907E+01 | 1.26860E−07 | −1.21130E−08 | 7.13030E−10 | −2.33830E−11 | 3.22300E−13 |
| R3 | −3.88136E+00 | 8.51850E−08 | −6.40960E−09 | 2.84170E−10 | −5.77070E−12 | 0.00000E+00 |
| R4 | −3.21910E+00 | 2.16700E−08 | −8.22890E−09 | 4.42430E−10 | −7.56860E−12 | 0.00000E+00 |
| R5 | −2.20793E+01 | −7.35720E−07 | 5.18750E−08 | −1.98840E−09 | 3.30900E−11 | 0.00000E+00 |
| R6 | 4.88628E+00 | −2.31600E−06 | 1.91640E−07 | −8.77350E−09 | 1.72770E−10 | 0.00000E+00 |
| R7 | 7.52647E−01 | −4.17750E−07 | −2.50650E−08 | 1.97790E−09 | −5.82200E−12 | 0.00000E+00 |
| R8 | 1.88646E+00 | 5.43170E−07 | −2.09160E−07 | 1.77810E−08 | −4.96960E−10 | 0.00000E+00 |
| R9 | −5.01388E+00 | −4.27630E−06 | −5.63380E−08 | 2.63030E−08 | −1.08320E−09 | 0.00000E+00 |
| R10 | −1.84782E+00 | −1.07640E−05 | 9.11320E−07 | −4.24310E−08 | 8.33480E−10 | 0.00000E+00 |

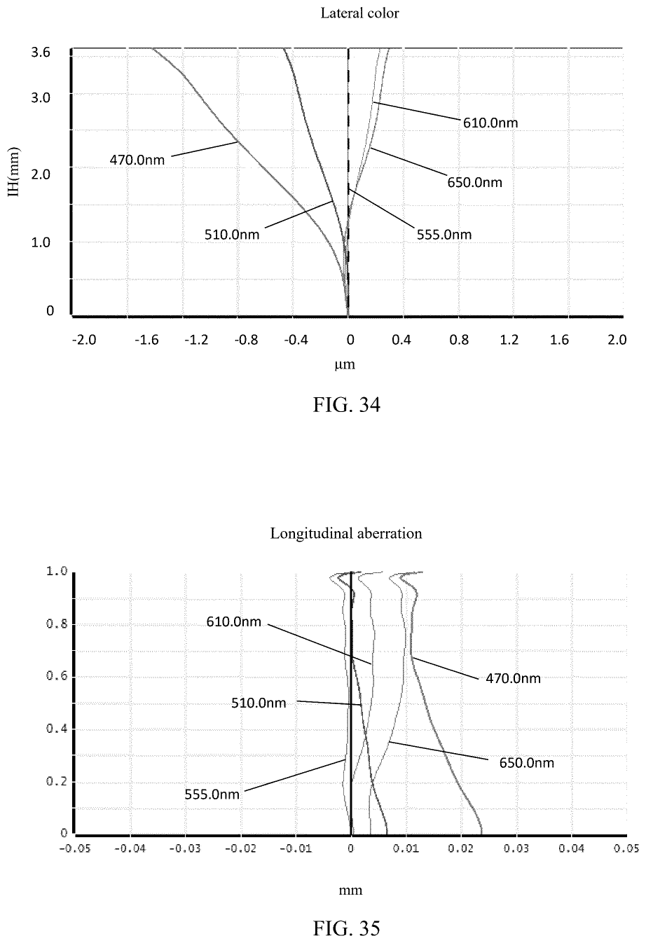

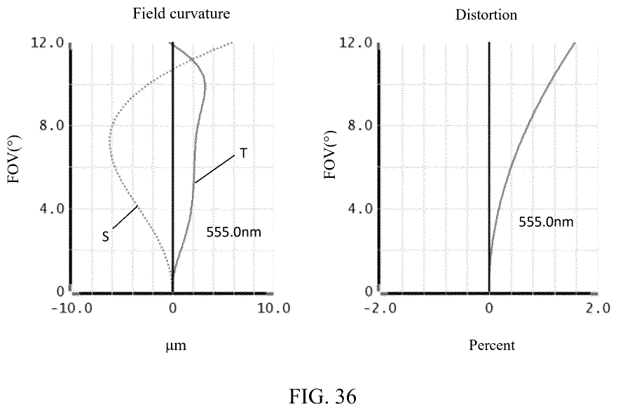

FIG. 34 and FIG. 35 show the longitudinal aberration and lateral color schematic diagrams after light with a wavelength of 650 nm, 610 nm, 555 nm, 510 nm and 470 nm passes the camera optical lens 50 of the fifth embodiment in the first state. FIG. 36 shows the field curvature and distortion schematic diagrams after light with a wavelength of 555 nm passes the camera optical lens 50 of the fifth embodiment in the first state, the field curvature S in FIG. 36 is a field curvature in the sagittal direction, T is a field curvature in the meridian direction.

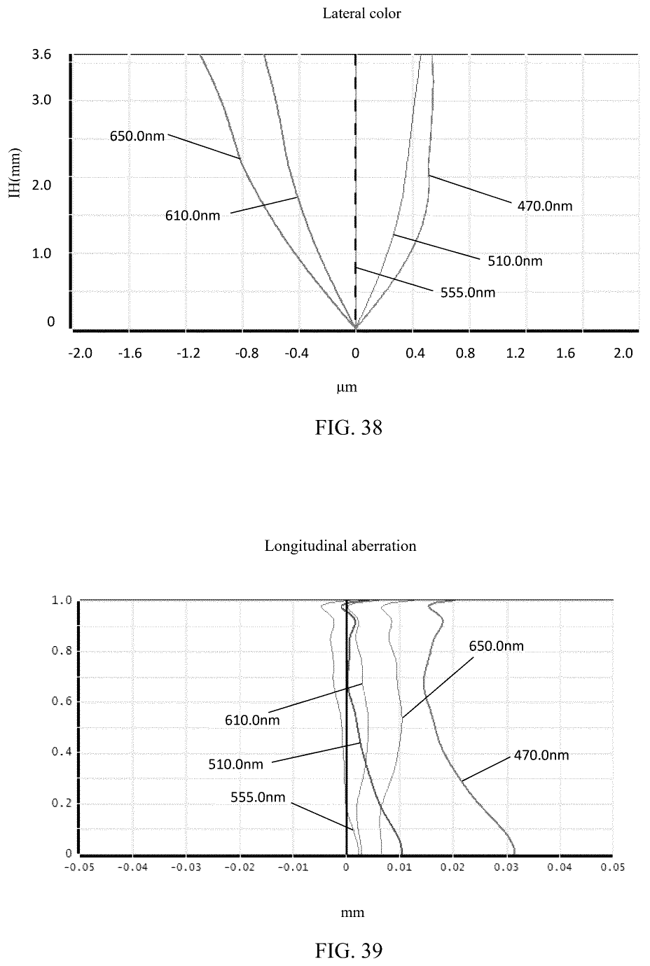

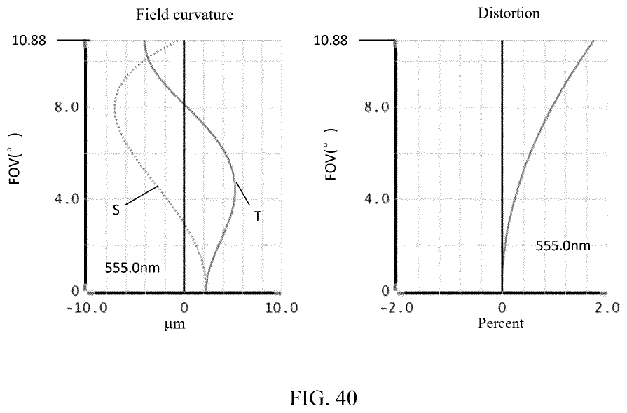

FIG. 38 and FIG. 39 show the longitudinal aberration and lateral color schematic diagrams after light with a wavelength of 650 nm, 610 nm, 555 nm, 510 nm and 470 nm passes the camera optical lens 50 of the fifth embodiment in the second state. FIG. 40 shows the field curvature and distortion schematic diagrams after light with a wavelength of 555 nm passes the camera optical lens 50 of the fifth embodiment in the second state, the field curvature S in FIG. 40 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the fifth embodiment satisfies all conditional expressions.

In this embodiment, the distance on-axis from the object side surface to the reflective surface of the first prism P1 is 5.000 mm, and the distance on-axis from the reflective surface to the image side surface of the first prism P1 is 4.800 mm.

In the first state, the entrance pupil diameter (ENPD) of the camera optical lens 50 is 8.000 mm, the full field image height (IH) is 3.600 mm, and the field of view (FOV) in the diagonal direction is 24.00°. The camera optical lens 50 satisfies the design requirements of a large aperture, long focal length, and miniaturization, with axial and off-axis chromatic aberrations sufficiently corrected, and exhibits superior optical characteristics.

### Embodiment 6

Embodiment 6 is basically the same as embodiment 1, the meaning of its symbols is the same as that of embodiment 1. Only differences are listed below. The image side surface of the first prism P1 is convex in the paraxial region.

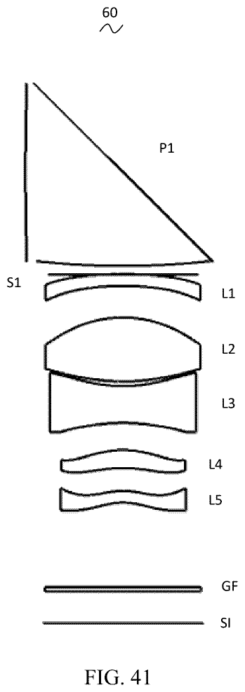

FIG. 41 shows a schematic structural diagram of the camera optical lens 60 according to the sixth embodiment of the present disclosure in the first state.

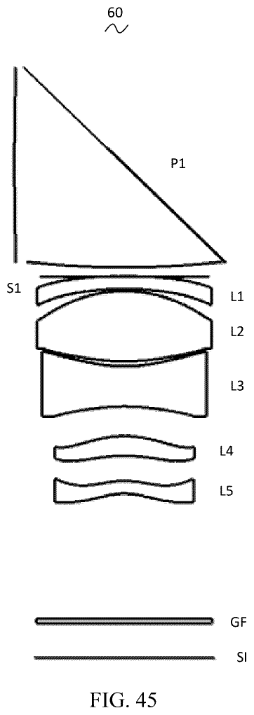

FIG. 45 shows a schematic structural diagram of the camera optical lens 60 according to the sixth embodiment of the present disclosure in the second state.

Table 16 present the design data of the camera optical lens 60 according to the sixth embodiment of the present disclosure.

TABLE 16

| | R | d | | nd | | νd | |
|---|---|---|---|---|---|---|---|
| S1 | ∞ | d0 | −10.235 | | | | |
| Rp1 | 101.794 | dp1 | 9.800 | nd1 | 1.8052 | v1 | 40.91 |
| Rp2 | −39.153 | dp2 | 0.421 | | | | |
| R1 | 27.508 | d1 | 0.600 | nd2 | 1.6400 | v2 | 23.54 |
| R2 | 15.271 | d2 | d2 | | | | |
| R3 | 6.007 | d3 | 3.285 | nd3 | 1.5444 | v3 | 55.82 |
| R4 | −9.742 | d4 | 0.241 | | | | |
| R5 | −7.033 | d5 | 1.882 | nd4 | 1.6153 | v4 | 25.94 |
| R6 | 8.584 | d6 | 1.390 | | | | |
| R7 | 4.472 | d7 | 0.926 | nd5 | 1.6700 | v5 | 19.39 |
| R8 | 6.256 | d8 | 1.171 | | | | |
| R9 | 3.427 | d9 | 0.600 | nd6 | 1.5346 | v6 | 55.69 |
| R10 | 2.965 | d10 | d10 | | | | |
| R11 | ∞ | d11 | 0.210 | ndg | 1.5168 | vg | 64.17 |
| R12 | ∞ | d12 | 1.628 | | | | |

Table 17 shows data of related optical parameters for the camera optical lens 60 according to the sixth embodiment of the present disclosure in a first state and a second state, respectively.

TABLE 17

| | First state | Second state |
|---|---|---|
| f | 16.672 | 16.446 |
| FOV | 24.00° | 21.78° |
| FNO | 2.08 | 2.06 |
| dp2 | 1.622 | 0.100 |
| d10 | 6.192 | 7.714 |

Table 18 shows the aspherical surface data of each lens in the camera optical lens 60 in the embodiment 6 of the present disclosure.

TABLE 18

| | Conic Index | Aspherical Surface Index | | | | |
|---|---|---|---|---|---|---|
| | k | A4 | A6 | A8 | A10 | A12 |
| Rp1 | 5.19267E+01 | −1.25870E−04 | −2.24570E−07 | 4.03180E−08 | −7.78710E−10 | −7.37060E−10 |
| Rp2 | 0.00000E+00 | 0.00000E+00 | 0.00000E+00 | 0.00000E+00 | 0.00000E+00 | 0.00000E+00 |
| R1 | 3.57300E+01 | 9.74560E−04 | 4.89520E−05 | −3.52950E−05 | 9.89500E−06 | −1.73550E−06 |
| R2 | 1.08108E+01 | 6.87170E−04 | 3.67040E−05 | −3.30200E−05 | 9.62330E−06 | −1.75210E−06 |
| R3 | −4.76424E+00 | 2.74430E−03 | −1.13510E−04 | 5.74560E−06 | 2.29120E−07 | −1.01190E−07 |
| R4 | −4.09186E+00 | 9.97670E−04 | −5.59140E−04 | 2.56220E−04 | −5.66250E−05 | 7.08620E−06 |
| R5 | −2.27740E+01 | −6.89180E−03 | 1.12830E−03 | 8.48740E−06 | −3.50940E−05 | 6.67220E−06 |
| R6 | 4.60192E+00 | −5.32760E−03 | 2.37060E−04 | 1.69160E−04 | −7.34160E−05 | 1.53080E−05 |
| R7 | 6.20281E−01 | −7.49580E−03 | −3.58720E−05 | 5.78540E−05 | −2.88920E−05 | 4.59330E−06 |
| R8 | 1.93266E+00 | −1.02710E−02 | 1.06560E−03 | −2.02900E−04 | 2.01210E−05 | −3.48830E−06 |
| R9 | −4.50274E+00 | −1.75280E−02 | −7.25120E−04 | 6.51800E−04 | −1.24720E−04 | 7.82400E−06 |
| R10 | −1.84200E+00 | −2.22850E−02 | 8.74240E−04 | 5.82090E−04 | −1.95600E−04 | 3.43580E−05 |

| | |
|---|---|
| Conic Index | Aspherical Surface Index |

| | k | A14 | A16 | A18 | A20 | A22 |
|---|---|---|---|---|---|---|
| Rp1 | 5.19267E+01 | 1.13700E−10 | −7.48480E−12 | 2.37510E−13 | −2.96840E−15 | 0.00000E+00 |
| Rp2 | 0.00000E+00 | 0.00000E+00 | 0.00000E+00 | 0.00000E+00 | 0.00000E+00 | 0.00000E+00 |
| R1 | 3.57300E+01 | 1.97660E−07 | −1.45660E−08 | 6.68670E−10 | −1.73670E−11 | 1.94640E−13 |
| R2 | 1.08108E+01 | 2.06050E−07 | −1.56280E−08 | 7.35810E−10 | −1.95320E−11 | 2.22570E−13 |
| R3 | −4.76424E+00 | 1.08670E−08 | −6.43560E−10 | 2.14690E−11 | −3.50350E−13 | 0.00000E+00 |
| R4 | −4.09186E+00 | −5.37790E−07 | 2.46970E−08 | −6.40090E−10 | 7.31020E−12 | 0.00000E+00 |
| R5 | −2.27740E+01 | −6.52050E−07 | 3.70780E−08 | −1.17510E−09 | 1.62250E−11 | 0.00000E+00 |
| R6 | 4.60192E+00 | −1.93360E−06 | 1.50290E−07 | −6.66640E−09 | 1.28920E−10 | 0.00000E+00 |
| R7 | 6.20281E−01 | −4.70940E−07 | 3.92900E−08 | −2.46100E−09 | 6.89380E−11 | 0.00000E+00 |
| R8 | 1.93266E+00 | 7.34020E−07 | −8.60060E−08 | 4.85110E−09 | −1.06320E−10 | 0.00000E+00 |
| R9 | −4.50274E+00 | 1.19040E−06 | −2.69010E−07 | 1.98520E−08 | −5.33820E−10 | 0.00000E+00 |
| R10 | −1.84200E+00 | −3.67950E−06 | 2.35430E−07 | −8.13240E−09 | 1.13480E−10 | 0.00000E+00 |

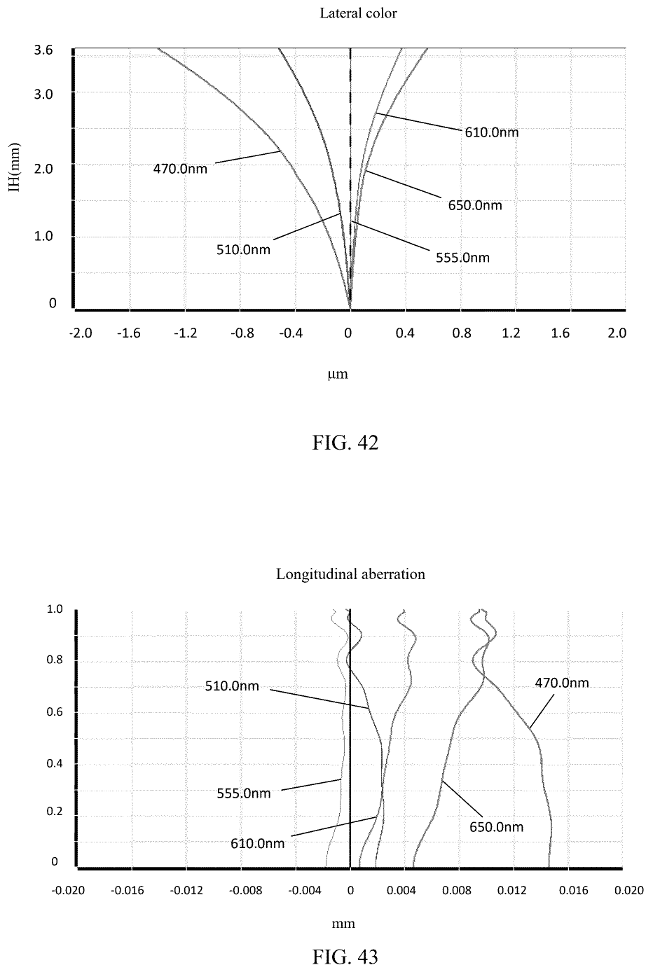

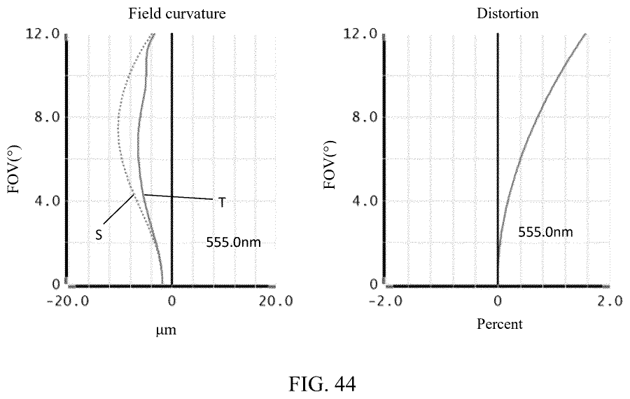

FIG. 42 and FIG. 43 show the longitudinal aberration and lateral color schematic diagrams after light with a wavelength of 650 nm, 610 nm, 555 nm, 510 nm and 470 nm passes the camera optical lens 60 of the sixth embodiment in the first state. FIG. 44 shows the field curvature and distortion schematic diagrams after light with a wavelength of 555 nm passes the camera optical lens 60 of the sixth embodiment in the first state, the field curvature S in FIG. 44 is a field curvature in the sagittal direction, T is a field curvature in the meridian direction.

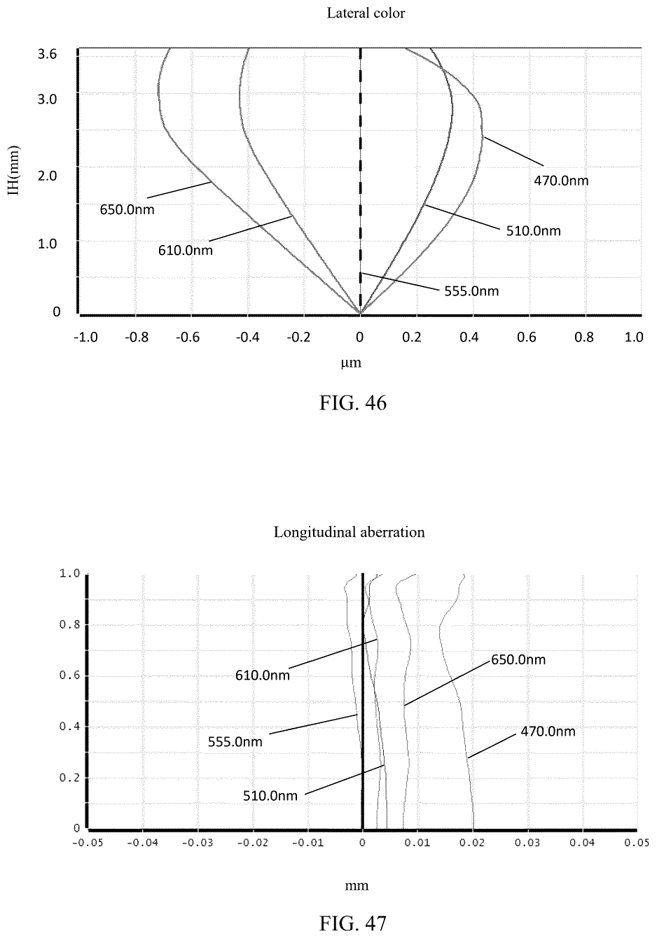

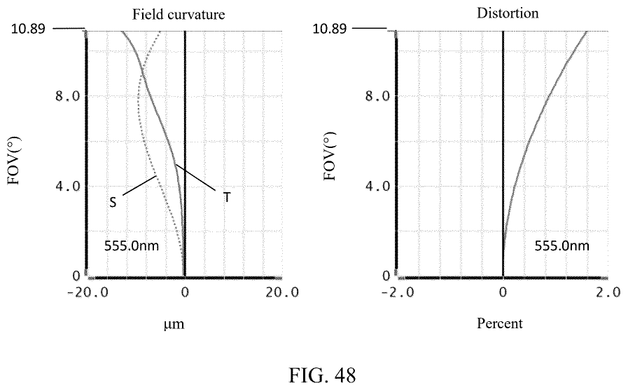

FIG. 46 and FIG. 47 show the longitudinal aberration and lateral color schematic diagrams after light with a wavelength of 650 nm, 610 nm, 555 nm, 510 nm and 470 nm passes the camera optical lens 60 of the sixth embodiment in the second state. FIG. 48 shows the field curvature and distortion schematic diagrams after light with a wavelength of 555 nm passes the camera optical lens 60 of the sixth embodiment in the second state, the field curvature S in FIG. 48 is a field curvature in the sagittal direction, T is a field curvature in the meridian direction.

Subsequent Table 19 lists the values corresponding to specified parameters in the conditional expressions for each of Embodiments 1, 2, 3, 4, 5, and 6.

As shown in Table 19, the sixth embodiment satisfies all conditional expressions.

In this embodiment, the distance on-axis from the object side surface to the reflective surface of the first prism P1 is 5.000 mm, and the distance on-axis from the reflective surface to the image side surface of the first prism P1 is 4.800 mm.

In the first state, the entrance pupil diameter (ENPD) of the camera optical lens 60 is 8.000 mm, the full field image height (IH) is 3.600 mm, and the field of view (FOV) in the diagonal direction is 24.000. The camera optical lens 60 satisfies the design requirements of a large aperture, long focal length, and miniaturization, with axial and off-axis chromatic aberrations sufficiently corrected, and exhibits superior optical characteristics.

TABLE 19

| Parameters and | | | | |
|---|---|---|---|---|
| Conditional | | | | |
| Expressions | Embodiment 1 | Embodiment 2 | Embodiment 3 | Embodiment 4 |
| fA/IH | 4.88 | 4.70 | 4.63 | 4.63 |
| Rp1/Rp2 | 0.33 | 0.69 | 0.70 | −3.95 |
| fb/fa | 1.25 | 1.01 | 0.62 | 0.80 |
| BF/TTL | 0.34 | 0.39 | 0.29 | 0.17 |
| f4/(R7 + R8) | 0.78 | 0.88 | 1.00 | 2.90 |
| fA | 16.716 | 16.922 | 16.661 | 16.682 |
| fp1 | 51.189 | −280.775 | 65.394 | 59.003 |
| f1 | −22.557 | −68.397 | −30.413 | −139.882 |
| f2 | 6.943 | 7.701 | 7.317 | 7.673 |
| f3 | −8.282 | −8.507 | −8.289 | −7.995 |
| f4 | 22.062 | 29.152 | 25.091 | 33.383 |
| f5 | −7562.100 | 169.296 | 67.352 | −39.709 |
| TTL | 27.551 | 31.000 | 27.065 | 28.444 |
| IH | 3.600 | 3.600 | 3.600 | 3.600 |

| Parameters and | | |
|---|---|---|
| Conditional | | |
| Expressions | Embodiment 5 | Embodiment 6 |
| fA/IH | 4.63 | 4.63 |
| Rp1/Rp2 | −1.25 | −2.60 |
| fb/fa | 0.31 | 0.54 |
| BF/TTL | 0.26 | 0.22 |
| f4/(R7 + R8) | 1.78 | 1.79 |
| fA | 16.672 | 16.672 |
| fp1 | 25.803 | 36.082 |
| f1 | −31.821 | −54.280 |
| f2 | 7.492 | 7.344 |
| f3 | −6.422 | −5.965 |
| f4 | 19.470 | 19.179 |
| f5 | −105.265 | −74.934 |
| TTL | 26.678 | 28.130 |
| IH | 3.600 | 3.600 |

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms where the appended claims are expressed.

What is claimed is:

1. A camera optical lens comprising, in an order from an object side to an image side in sequence: a first prism, a first lens with a negative refractive power, a second lens with a positive refractive power, a third lens with a negative refractive power, a fourth lens with a positive refractive power, and a fifth lens; wherein
the first lens is defined as a first lens group, while the second, third, fourth, and fifth lenses are defined as a second lens group, the second lens group is adjustably movable along the optical axis of the camera optical lens to switch the camera optical lens between a first state and a second state, the camera optical lens achieves its maximum focal length in the first state, and achieves its minimum focal length in the second state;
a reflective surface is disposed between the object side surface and image side surface of the first prism, and the camera optical lens further satisfies the following conditions:
$$\begin{matrix}4.6 \leq fA / IH \leq 4.9 ; \\ - 4. \leq Rp 1 / Rp 2 \leq 0.71 ; \\ 0.3 \leq fb / fa \leq 1.3 ; \\ 0.15 \leq BF / TTL \leq 0 \text{.40} ;\end{matrix}$$
where
fA: the focal length of the camera optical lens in the first state;
IH: the image height of the camera optical lens;
Rp1: the central curvature radius of the object side surface of the first prism;
Rp2: the central curvature radius of the image side surface of the first prism;
fb: the focal length of the second lens group when the camera optical lens in the first sate;
fa: the focal length of non-prism section excluding the first prism when the camera optical lens in the first sate;
BF: the distance from the image side surface of the fifth lens to the image side when the camera optical lens in the first state;
TTL: the total optical length of the camera optical lens.

2. The camera optical lens as described in claim 1 further satisfies the following condition:
$$0.7 \leq f 4 / ( R 7 + R 8 ) \leq 3 \text{.00} ;$$
where
f4: the focal length of the fourth lens;
R7: the central curvature radius of the object side surface of the fourth lens;
R8: the central curvature radius of the image side surface of the fourth lens.

3. The camera optical lens as described in claim 1 further satisfies the following conditions:
$$\begin{matrix}- 16. 60 \leq fp 1 / fA \leq 3.93 ; \\ 0.3 \leq dp 1 / TTL \leq 0.37 ;\end{matrix}$$
where
fp1: the focal length of the first prism;
dp1: the sum of the distance on-axis from the object side surface of the first prism to the reflective surface, and the distance on-axis from the reflective surface to the image side surface of the first prism.

4. The camera optical lens as described in claim 1, wherein an object side surface of the first lens is convex in the paraxial region, an image side surface of the first lens is concave in the paraxial region, and the camera optical lens further satisfies the following conditions:
$$\begin{matrix}- 8.3 \; 9 \leq f 1 / fA \leq - 1 \text{.34} ; \\ 1.91 \leq ( R 1 + R 2 ) / ( R 1 - R 2 ) \leq 13 \text{.57} ; \\ 0.019 \leq d 1 / TTL \leq 0.0 \; 23 ;\end{matrix}$$
where
f1: the focal length of the first lens;
R1: the central curvature radius of the object side surface of the first lens;
R2: the central curvature radius of the image side surface of the first lens;
d1: the thickness on-axis of the first lens.

5. The camera optical lens as described in claim 1, wherein an object side surface of the second lens is convex in the paraxial region, an image side surface of the second lens is convex in the paraxial region, and the camera optical lens further satisfies the following conditions:
$$\begin{matrix}0.41 \leq f 2 / fA \leq 0.46 ; \\ - 0.42 \leq ( R 3 + R 4 ) / ( R 3 - R 4 ) \leq 0. ; \\ 0.089 \leq d 3 / TTL \leq 0.1 \; 17 ;\end{matrix}$$
where
f2: the focal length of the second lens;
R3: the central curvature radius of the object side surface of the second lens;
R4: the central curvature radius of the image side surface of the second lens;
d3: the thickness on-axis of the second lens.

6. The camera optical lens as described in claim 1, wherein an object side surface of the third lens is concave in the paraxial region, an image side surface of the third lens is concave in the paraxial region, and the camera optical lens further satisfies the following conditions:
$$\begin{matrix}- 0.51 \leq f 3 / fA \leq - 0.35 ; \\ - 0.6 \leq ( R 5 + R 6 ) / ( R 5 - R 6 ) \leq - 0.06 ; \\ 0.016 \leq d 5 / TTL \leq 0.0 \; 67 ;\end{matrix}$$
where
f3: the focal length of the third lens;
R5: the central curvature radius of the object side surface of the third lens;
R6: the central curvature radius of the image side surface of the third lens;
d5: the thickness on-axis of the third lens.

7. The camera optical lens as described in claim 1, wherein an object side surface of the fourth lens is convex in the paraxial region, an image side surface of the fourth lens is concave in the paraxial region, and the camera optical lens further satisfies the following conditions:
$$\begin{matrix}1.15 \leq f 4 / fA \leq 2.01 ; \\ - 10. 17 \leq ( R 7 + R 8 ) / ( R 7 - R 8 ) \leq - 2 \text{.55} ; \\ 0.025 \leq d 7 / TTL \leq 0.0 \; 33 ;\end{matrix}$$
where
f4: the focal length of the fourth lens;
R7: the central curvature radius of the object side surface of the fourth lens;
R8: the central curvature radius of the image side surface of the fourth lens;
d7: the thickness on-axis of the fourth lens.

8. The camera optical lens as described in claim 1, wherein an object side surface of the fifth lens is convex in the paraxial region, an image side surface of the fifth lens is concave in the paraxial region, and the camera optical lens further satisfies the following conditions:
$$\begin{matrix}- 452.41 \leq f 5 / fA \leq 10.01 ; \\ 6.81 \leq ( R 9 + R 10 ) / ( R 9 - R 10 ) \leq 52.78 ; \\ 0.019 \leq d 9 / TTL \leq 0.0 \; 39 ;\end{matrix}$$
where
f5: the focal length of the fifth lens;
R9: the central curvature radius of the object side surface of the fifth lens;
R10: the central curvature radius of the image side surface of the fifth lens;
d9: the thickness on-axis of the fifth lens.

9. The camera optical lens as described in claim 1, wherein the first prism is made of glass material.
